(19) United States
(12) Patent Application Publication
(10) Pub. No.: US 2026/0169445 A1
(43) Pub. Date: Jun. 18, 2026

(54) METHODS AND ARRANGMENTS FOR PROCESS ANALYTICAL TECHNOLOGY MANAGEMENT AND OPERATION

(71) Applicant: Arranta Bio Holdings, LLC, Watertown, MA (US)

(72) Inventors: Edita Botonjic-Sehic, Watertown, MA (US); Hossein Hamedi, Watertown, MA (US); Aaron Cowley, Watertown, MA (US); Syed Kaschif Ahmed, Watertown, MA (US)

(21) Appl. No.: 19/424,234

(22) Filed: Dec. 18, 2025

Related U.S. Application Data
(60) Provisional application No. 63/735,432, filed on Dec. 18, 2024.

(51) Int. Cl. G05B 13/02

(52) U.S. Cl. CPC G05B 13/0265

(57) ABSTRACT

Logic may establish monitoring for a Critical Quality Attribute (CQA) in real-time for an in-line instrument. The logic may establish one or more parameters for collecting measurement data from the in-line instrument, wherein the measurement data comprises an array of raw data per measurement. The logic may select a machine learning model from a library of machine learning models, the machine learning model to generate a prediction for the CQA. The logic may collect, based on the one or more parameters, the measurement data in real-time from the in-line instrument. The logic may process the measurement data from the in-line instrument to generate real-time transformed data for the CQA and to predict a model output, the model output comprising trending data for the CQA. And the logic may store the raw data, the real-time transformed data, and the trending data in a data storage device.

### CROSS REFERENCE TO RELATED APPLICATIONS

This application claims priority to U.S. Provisional Application No. 63/735,432 filed Dec. 18, 2024, the contents of which are hereby incorporated by reference in their entirety.

### FIELD OF THE INVENTION

The present invention relates to improvements to process analytic technology (PAT) management and operation for use in, e.g., a continuous pharmaceutical and biopharmaceutical manufacturing system.

### BACKGROUND

Biomanufacturing relies on analytical testing of critical quality attributes (CQAs) between unit operation to ensure drug substance (DS) and drug product (DP) meet industry and regulatory standards. Analytical testing can be performed using off-line, at-line, on-line, and/or in-line methods. As process analytical technologies advance, more instruments are developed that can measure CQAs using in-line methods. The benefit of in-line methods is that it can measure CQAs in real-time. Real-time measurements don't require human intervention and can be automated to measure according to process schedule. On the other hand, some real-time measurements require post-processing of data and modelling to obtain CQAs. An example of these techniques is spectroscopic instruments such as process Raman analyzers. Spectroscopic instruments produce an array of data per measurement that is called spectra. To convert spectra to CQAs, signal processing and multivariate modelling techniques are employed. These data analysis techniques are often called chemometrics. Chemometrics requires special commercial software or programming languages to be implemented on real-time data generated by process analytical technologies. Therefore, to measure CQAs in real-time, beside appropriate in-line instruments, data analysis platforms are required to process data.

Biomanufacturing industry has come up with solutions to manage in-line process analytical technology (PAT) and chemometrics software—PAT management software. These solutions are provided by the private sector and often are inflexible toward biopharmaceutical companies process requirements as these solutions are designed to be a general purpose for all the biopharmaceutical industry. For example, a solution might meet requirements of the monoclonal antibodies processing but could not meet requirements of RNA therapeutics due to type of process analytical technologies being used.

Commercial PAT management software requires adaptation of new instruments and technologies that can be time-consuming and costly. Besides, they are designed to execute chemometrics models using commercial software which require additional cost and maintenance. Commercial software excels at one type of model and is limited to other types of models. With the recent advances in machine learning models and artificial intelligence, open-source programming languages such as Python are becoming more attractive in the biopharmaceutical industry. Although some commercial PAT management software added Python capability, when it comes to practice, incorporating Python models is cumbersome.

Commercial PAT management software has three main functions. The first main function is the chemometrics, which is basically a toolbox of algorithms that can be used to develop models for instruments. The second main function is adaptation, which includes some adapters for instruments. The third main function is data handling.

Data handling is a central database of in-line PAT measurements. Commercial software provides this feature, however, accessing data is limited to one batch at a time and biopharmaceutical companies will need to develop additional data solutions should they desire to perform additional data analysis. For example, to perform a batch-to-batch comparison, data export and staging from commercial software is a cumbersome and manual task.

### BRIEF SUMMARY

An embodiment of a method, apparatus, system, and computer-readable medium may establish monitoring for a Critical Quality Attribute (CQA) in real-time for an in-line instrument of a manufacturing process. The embodiment may include an instrument control module for collecting measurement data from the in-line instrument, wherein the measurement data comprises an array of raw data per measurement and a multivariate modelling module for selecting a machine learning model for the in-line instrument from a library of machine learning models, based on the manufacturing process and a stage of the manufacturing process associated with an interconnection of the in-line instrument with the manufacturing process, to generate a prediction for the CQA based on data collected from the in-line instrument. The embodiment may include the instrument control module for collecting, based on the one or more parameters, the measurement data in real-time from the in-line instrument; the multivariate model module for processing the measurement data from the in-line to generate real-time transformed data for the CQA and to predict a model output, the model output comprising trending data for the CQA; and storing the trending data in a data storage device.

Some embodiments may pass the trending data to a management and orchestration system. Some embodiments may display the real-time transformed data and trending data on a display. In some embodiments, the instrument control module may connect with the in-line instrument comprising a Raman analyzer and a specific unit operation for the Raman analyzer comprises in vitro transcription (IVT) reaction.

In some embodiments, the CQA comprises a volume, a concentration, or a mass. Some embodiments comprise the library of machine learning models stored in a local data storage or a web-based data storage connected to a model execution module comprising a set of specific unit operations for a process for manufacturing a pharmaceutical or biopharmaceutical product. In some embodiments, the set of specific unit operations comprise one of a IVT reaction, IVT pool, IVT pool dilution, tangential flow filtration 1 (TFF1) pool, TFF1 dilution, Oligo dT pool, tangential flow filtration 2 (TFF2) pool/release DS, lipid solution, DS dilution, LNP pool, tangential flow filtration 3 (TFF3) pool, post-sucrose, bulk DP, and release DP.

In some embodiments, the in-line instrument includes one of a mRNA concentration—A260 (nanodrop), a mRNA concentration—Florescence (RiboGreen), an encapsulation—Florescence (RiboGreen), a mRNA purity—CE (Frag A), a mRNA integrity—CE (Frag A), a mRNA intactness, a percentage of fragmentation mRNA, an aggregate quantitation, a dsRNA content—Dot blot, a LNP size, polydispersity—DLS, a LNP surface charge morphology (—potential, a residual total protein—florescence (NanoOrange), a residual plasmid DNA—qPCR, a visual appearance—USP<790>, a subvisible particles, a particulate matter, a sucrose concentration—LC/CAD, a total lipid (ionizable, PEG, DSPC, cholesterol), an osmolality—mOsm/kg H₂O, a viscosity—USP<911>, a residual solvents, a residual E. coli HCP—ELISA, a residual nucleotides NTP—LC/MS, a pH, a bioburden Sterility—USP<1><61><71>, an endotoxin—USP<85>, a 5′ Capping efficiency—LC/MS, a 3′ poly(A) tail length variant distribution LC/MS, a sequence identification—illumina Sanger, a IVT potency—cell-based assay, a mRNA purity—LC CE Bioanalyzer, a mRNA content—UPLC and Rib green, a mRNA/Lipid mass (N:P ratio), an extractable volume, a container closure integrity (CCIT), and an immunogenicity.

In some embodiments, storing the trending data in a data storage device comprises measurement sequencing, wherein measurement sequencing comprises storing the raw data, the real-time transformed data, and the trending data in a centralized database of PAT measurements and machine learning model outputs. In some embodiments, the centralized database is accessible via a structured query language (SQL). In some embodiments, measurement sequencing may include acquiring measurement data, monitoring measurements status, raising errors if measurements fail, storing raw measurement data, transferring raw measurement data to a model execution web app, receiving transformed data and model outputs from the model execution web app, and storing transformed data and model outputs.

In some embodiments, the raw data, the real-time transformed data, the trending data, and the machine learning models are auditable. In some embodiments, the data storage device maintains, for the data storage device, audit trails, version control, and security such as user authentication and user groups.

Some embodiments may enable two-way communication between any PAT that is capable of transferring data using Open Platform Communications Unified Architecture (OPC-UA) and Representational State Transfer Application Programming Interface (RestAPI).

In some embodiments, establishing one or more parameters may comprise commanding acquisition parameters or measurement configurations for the in-line instrument.

In some embodiments, the multivariate modelling module may process the measurement data by enabling execution of Python models in the model execution web app in real-time. In some embodiments, the model execution web app receives the raw measurement data from the measurement sequencing and runs Python codes to process raw measurement data. In some embodiments, the model execution web app executes Python models that can handle real-time data and infer a model output, such as a prediction of trending data, in real-time. In some embodiments, the Python models may comprise pre-treatment methods including interpolating functions, derivation, and normalization; multivariate models including principal component analysis (PCA) and partial least square (PLS) regression; and hybrid models by combining mechanistic equations and multivariate models.

In many embodiments, the PAT management and operations system may enable concurrent operation of multiple instruments and models.

### BRIEF DESCRIPTION OF THE SEVERAL VIEWS OF THE DRAWINGS

Non-limiting embodiments of the present disclosure are described by way of example with reference to the accompanying drawings, which are schematic and not intended to be drawn to scale. The accompanying drawings are provided for purposes of illustration only, and the dimensions, positions, order, and relative sizes reflected in the figures in the drawings may vary. In the figures, identical or nearly identical or equivalent elements are typically represented by the same reference characters, and similar elements are typically designated with similar reference numbers, with redundant description omitted. For purposes of clarity and simplicity, not every element is labeled in every figure, nor is every element of each embodiment shown where illustration is not necessary to allow those of ordinary skill in the art to understand the disclosure.

To easily identify the discussion of any particular element or act, the most significant digit or digits in a reference number refer to the figure number in which that element is first introduced.

FIG. 1 illustrates an aspect of a system in accordance with one embodiment.

FIG. 2 illustrates an aspect of another system in accordance with one embodiment.

FIG. 3 illustrates an aspect of another system in accordance with one embodiment.

FIG. 4 illustrates an example of CQAs and the corresponding point of measurement for Ribonucleic acid (RNA)/Lipid nanoparticles (LNP) production in accordance with one embodiment.

FIG. 5 illustrates a process for a PAT management and operations system in accordance with one embodiment.

FIG. 6 illustrates an aspect of a computer system for execution of code of a PAT management and operations system in accordance with one embodiment.

FIG. 7 illustrates an aspect of a storage medium to store code of a PAT management and operations system in accordance with one embodiment.

FIG. 8 illustrates an aspect of a computing platform of a PAT management and operations system in accordance with one embodiment.

FIG. 9 is a schematic illustrating an embodiment of a PAT Box apparatus.

FIG. 10 is a schematic illustrating an embodiment of an in-line flow cell head of a PAT Box apparatus.

FIG. 11 is a schematic showing the flow of data and process material between a PAT Box apparatus and a vessel, recirculation loop, or other process equipment, in accordance with one embodiment.

FIG. 12 is a schematic of a PAT Box apparatus in accordance with one embodiment, showing connection to an external vessel which may be, e.g., a release tank, a hold tank, or a dilution tank such as a flow path connected between the external vessel and the PAT Box apparatus to recirculate process fluid through inline flow cells to measure quality attributes.

FIG. 13A is a schematic illustrating the modular framework of the PAT Box apparatus.

FIG. 13B is a schematic illustrating a modular framework of the PAT Management software for the PAT Box apparatus.

FIG. 13C-N illustrates embodiments of graphical user interfaces for a PAT management software of a PAT Box apparatus.

FIG. 14A is a schematic showing data flow between the human machine interface (HMI) and advanced process controller (APC) of the PAT Control Cabinet with the PAT instrument stack containing instruments and associated flow cells, probes, etc. Also depicted is the flow of process fluid in a recirculation loop between the PAT instrument stack and a unit operation such as a reactor or other process equipment, or a vessel, such as a release tank, a hold tank, or a dilution tank.

FIG. 14B is a schematic showing data flow between the HMI and APC of the PAT Control Cabinet with two PAT instrument stacks each connected to a different unit operation or vessel.

FIG. 15 is a schematic illustration in accordance with one embodiment showing flow cells of the PAT Box apparatus in a series and parallel configurations.

FIG. 16 is a schematic illustrating an exemplary biopharmaceutical manufacturing system in accordance with one embodiment where several PAT Box apparatuses are connected between unit operations via a vessel, such as a surge vessel and another PAT Box apparatus is situated in-line between unit operations.

### DETAILED DESCRIPTION

Embodiments may generally provide methods, apparatuses, systems, and articles of manufacture for PAT management and operations with real-time analysis and trending for real-time monitoring of CQAs for in-line instruments. Embodiments may configure in-line instruments, provide machine learning models such as multivariate modelling, and provide visualization and analytics for outputs of machine learning models. Some embodiments may provide machine learning models to specifically target CQAs based on the manufacturing process and a stage of the manufacturing process associated with an interconnection of the in-line instrument with the manufacturing process. For instance, some embodiments may include models to target specific molecules to provide concentrations or other CQAs and trends in real-time.

Many embodiments may manage, orchestrate, and store data for in-line instruments. Some embodiments may access stored data for process sensors and off-line instruments to create plots, perform analytics, and/or combine process data to show different aspects of real-time monitoring.

Many embodiments are designed and configured to achieve goals of rapid process development, centralized process control, maintain a centralized database of PAT measurements and machine learning model outputs, and maintain good manufacturing practice and code of federal regulations (CFR 21) compliance. In several embodiments, rapid process development may involve provision of predictive models for a continuous and integrated process in real-time. Such embodiments may use real-time CQA testing and real-time release.

Many embodiments may incorporate a centralized process control by providing a single-point operation control. For instance, a user may click on a measurement for the PAT management and operations system and enter parameters to configure the collection of data for in-line instruments, obtain an instrument status, or start and stop data collection.

In several embodiments, the PAT management and operations systems may maintain a local or remote database for raw instrument data, processed instrument data, and machine learning model outputs. In some embodiments, the stored data may be easily accessible via a programming language such as a structured query language (SQL). With customized PAT management and operation systems that can handle programming languages such as structured query language (SQL), data analytics may be an automated and easier task.

Many embodiments may maintain good manufacturing practice and code of federal regulations (CFR 21 Part 11) compliance by offering auditable data and machine learning models. In some aspects, the auditable data and machine learning models may be stored in a data storage device that maintains audit trails, version control, and security including user authentication and user groups.

In several embodiments, the PAT management and operations system may be an integral part of smart manufacturing that, advantageously, provides real-time information for CQAs. Real-time monitoring of CQAs has been shown to reduce risk of batch failure in biomanufacturing by providing opportunities to mitigate process risks before batch failures occur.

Biomanufacturing runs are expensive especially in RNA manufacturing due to the high cost of raw materials. In many embodiments, the PAT management and operations systems may, advantageously, reduce the cost of real-time monitoring compared to current commercial solutions as they often require the purchase of multiple licenses. Besides, the PAT management and operations system may be supported immediately instead of communicating to multiple vendors in case of commercial solutions. This advantageously reduces the time of real-time monitoring implementation and support.

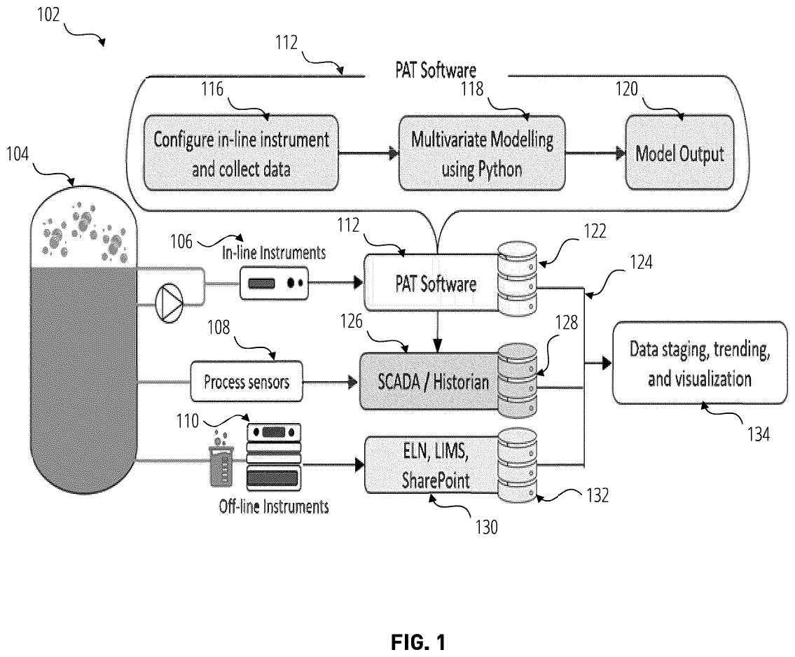

FIG. 1 illustrates a system 102 of a process with in-line instruments 106, process sensors 108, and off-line instruments 110. The system 102 may also comprise a PAT management and operations system 112 with PAT software comprising a configure in-line instrument and collect data module 116, a multivariate modelling module 118, and a model output module 120. The PAT management and operations system 112 may manage, configure, and collect measurement data from the in-line instruments 106, input the measurement data into a machine learning model such as a multivariate model, generate a model output including real-time transformed data and trending for CQAs, and output the model output via display or other device to present the real-time transformed data and trending in, e.g., a plot or other visual output, for the CQAs.

The configure in-line instrument and collect data module 116 may interact with a user to establish one or more parameters for collection of raw measurement data from the in-line instruments 106. For instance, the configure in-line instrument and collect data module 116 may command acquisition parameters for the in-line instruments 106 to establish, e.g., a periodicity or other timing for acquisition of measurement data from the in-line instruments 106 and collect the data from the in-line instruments 106. Establishing the one or more parameters for collecting measurement data from the in-line instruments 106 may comprise establishing the one or more parameters specific to a manufacturing process and specific to each unit operation for the in-line instruments 106 in that manufacturing process.

The in-line instruments 106 may couple with a vessel 104 of the specific manufacturing process and have a specific unit operation in that manufacturing process. For example, at least one of the in-line instruments 106 may comprise a Raman analyzer and a specific unit operation for the Raman analyzer such as in vitro transcription (IVT) reaction. In some aspects, the specific unit operations comprise one of a IVT reaction, IVT pool, IVT pool dilution, tangential flow filtration 1 (TFF1) pool, TFF1 dilution, Oligo dT pool, tangential flow filtration 2 (TFF2) pool/release DS, lipid solution, DS dilution, LNP pool, tangential flow filtration 3 (TFF3) pool, post-sucrose, bulk DP, and release DP. In some aspects, the in-line instruments 106 may include one or more of a mRNA concentration—A260 (nanodrop), a mRNA concentration—Florescence (RiboGreen), an encapsulation—Florescence (RiboGreen), a mRNA purity—CE (Frag A), a mRNA integrity—CE (Frag A), a mRNA intactness, a percentage of fragmentation mRNA, an aggregate quantitation, a dsRNA content—Dot blot, a LNP size, polydispersity—DLS, a LNP surface charge morphology ζ-potential, a residual total protein—florescence (NanoOrange), a residual plasmid DNA—qPCR, a visual appearance—USP<790>, a subvisible particles, a particulate matter, a sucrose concentration—LC/CAD, a total lipid (ionizable, PEG, DSPC, cholesterol), an osmolality—mOsm/kg H₂O, a viscosity—USP<911>, a residual solvents, a residual E. coli HCP—ELISA, a residual nucleotides NTP—LC/MS, a pH, a bioburden Sterility—USP<1><61><71>, an endotoxin—USP<85>, a 5′ Capping efficiency—LC/MS, a 3′ poly(A) tail length variant distribution LC/MS, a sequence identification—illumina Sanger, a IVT potency—cell-based assay, a mRNA purity—LC CE Bioanalyzer, a mRNA content—UPLC and Rib green, a mRNA/Lipid mass (N:P ratio), an extractable volume, a container closure integrity (CCIT), and an immunogenicity.

The multivariate modelling module 118 may receive the measurement data from the configure in-line instrument and collect data module 116 and run, e.g., Python codes or other codes to process raw measurement data and execute a machine learning model, from a library of machine learning models in a data storage device, that is specific to a unit operation for a specific process for manufacturing a pharmaceutical or biopharmaceutical product. In some embodiments the Python codes or other codes may execute locally and, in other embodiments, the Python codes or other codes may execute in a cloud server via a model execution web app. The model execution app may execute Python models that can handle real-time data execution to output real-time results. In some aspects, the Python models may comprise pre-treatment methods including interpolating functions, derivation, and normalization; machine learning models such as multivariate models including principal component analysis (PCA) and partial least square (PLS) regression; and hybrid models by combining mechanistic equations and multivariate models.

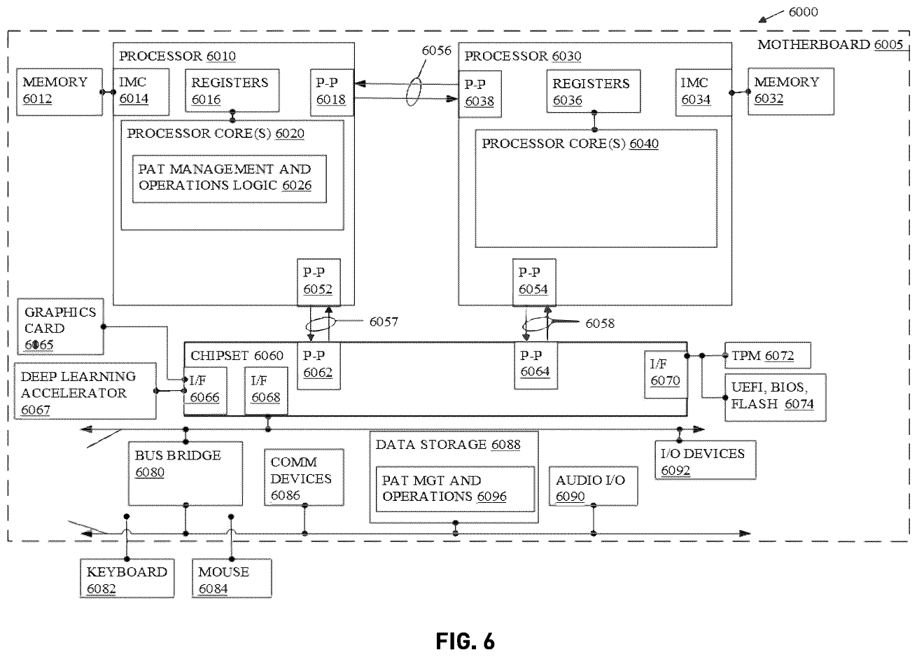

The multivariate modelling module 118 may perform measurement sequencing that includes acquiring measurement data, monitoring measurements status, raising errors if measurements fail, storing raw measurement data, transferring raw measurement data to a local model execution app or web app, receiving transformed data and model outputs from the model execution app or web app, and storing transformed data and model outputs in a local or remote data storage 122. In some aspects, the local or remote data storage 122 may comprise a centralized data storage for the PAT management and operations system 112. In some embodiments, the centralized data storage may comprise a centralized data server such as the computer 6000 shown in FIG. 6, which is accessible via a programming language such as a structured query language (SQL). In many embodiments, the raw measurement data, transformed data, and trending data in the data storage 122 are available to a data staging, trending, and visualization system 124 for further analytics and visualization.

The multivariate modelling module 118 may pass the transformed data and the model output to a model output module 120. The model output may include the transformed data such as a real-time CQA and trending data for the CQA. The machine learning model of the multivariate modelling module 118 may predict the trending data based on a library of trending data for the CQA for the specific unit operation in the specific process for manufacturing. In many embodiments, the CQA may include a volume, a concentration, or a mass.

The model output module 120 may display the real-time transformed data and trending data on a display, on a plot, or on another visual output locally and/or remotely in real-time.

In some embodiments, the PAT management and operations system 112 may enable two-way communication between any PAT, or in-line instrument, that is capable of transferring data using Open Platform Communications Unified Architecture (OPC-UA) and Representational State Transfer Application Programming Interface (RestAPI). In some aspects, the PAT management and operations system 112 may enable concurrent operation of multiple in-line instruments 106 and machine learning models in real-time.

The process sensors 108 may continuously or periodically collect data for the process in the vessel such as the temperature, pressure, and/or the like. The data collected by the process sensors 108 may be sent to a supervisory control and data acquisition (SCADA)/historian system 126. The SCADA/historian system 126 may store the data from the process sensors 108 in a database 128 or other data structure for use by a data staging, trending, and visualization system 124.

The off-line instruments 110 may collect samples for off-line analysis and may send the data for the samples to an electronic notebook (ELN), a laboratory information management system (LIMS), and/or SharePoint system 130 for storage in database 132 or other data structure. In aspects, the data captured by the ELN, LIMS, and/or SharePoint system is sent to the data staging, trending, and visualization system 124.

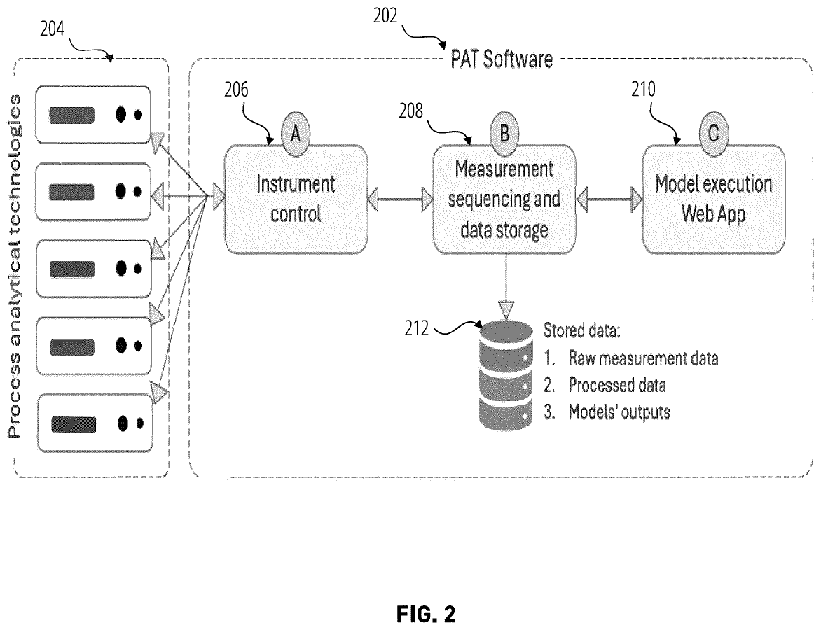

FIG. 2 illustrates another system of a process with in-line instruments (or PATs) 204 and a PAT management and operations system 202 with data flow indications and model execution in a web server. The PAT management and operations system 202 may include an instrument control module 206 such as the configure in-line instrument and collect data module 116 shown in FIG. 1, a measurement sequencing and data storage module 208, and a model execution web app 210. The instrument control module 206 may configure, manage, and collect raw measurement data from the in-line instruments 204 where the configuration flows from the instrument control module 206 to the in-line instruments 204 and the raw measurement data flows from the in-line instruments 204 to the instrument control module 206. The instrument control module 206 may also manage measurement data collection by receiving an instrument status from the in-line instruments 204 including instrument ready, instrument offline, and instrument configured. In some embodiments, the instrument control module 206 may manage the starting and stopping of collection of raw measurement data from one or more of the in-line instruments 204.

The instrument control module 206 passes the measurement data from the in-line instruments 204 to the measurement sequencing and data storage module 208. The measurement sequencing and data storage module 208 may acquire measurement data; monitor measurement status; raise errors to, e.g., a user via display or remotely messaging, if measurements fail; store raw measurement data in a PAT database 212 of a data storage device; and transfer raw measurement data to the model execution web app 210 for processing.

The model execution web app 210 may receive the raw measurement data for each of the in-line instruments 204 and enable execution of models such as Python models in a Python code concurrently, in real-time, to process the raw measurement data. Examples of the processing of raw measurement data include:
Pre-treatment methods (e.g., interpolating functions, derivation, and normalization),
Multivariate models including principal component analysis (PCA) and partial least square (PLS) regression, and
Hybrid models by combining mechanistic equations and multivariate models.

The model execution web app 210 may send transformed data and the model output to the measurement sequencing and data storage module 208. The transformed data may include CQAs and the model output may include trending data identified based on predictions of the machine learning models processing the raw measurement data and a library of trending data for the CQAs. Then the measurement sequencing and data storage module 208 may store raw measurements data, pretreated data, processed data, and models' output data in the data storage module 212 such as a central data server using, e.g., SQL. In the central data server, the data is readily available for external data analytics platforms.

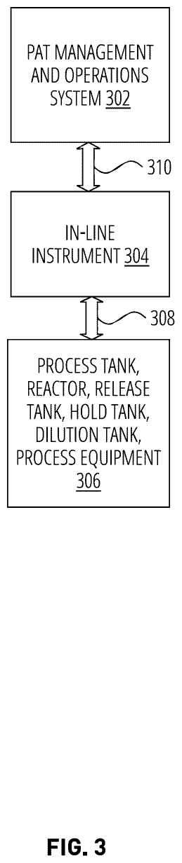

FIG. 3 schematically illustrates an embodiment of a PAT management and operations system 302 coupled with an in-line instrument 304 and a vessel 306 as described herein. The PAT management and operations system 302 may communicatively connect to the in-line instrument 304 to configure, manage, and collect data from the in-line instrument 304. The in-line instrument 304 may include one or more analytic instruments with associated flow cells and probes. Exemplary flow cells that may be included are a Raman flow cell, a UV/VIS flow cell, a mid-infrared (IR) flowcell, a near-IR flowcell, a DLS flowcell, and an index of refraction (IoR) flowcell. As illustrated, the in-line instrument 304 is in fluid communication with a unit operation of a pharmaceutical or biopharmaceutical manufacturing process, either directly or via an intervening vessel 306 coupled with the in-line instrument 304. The vessel 306 may be, for example, a process tank, a reactor, a release tank, a hold tank, or a dilution tank.

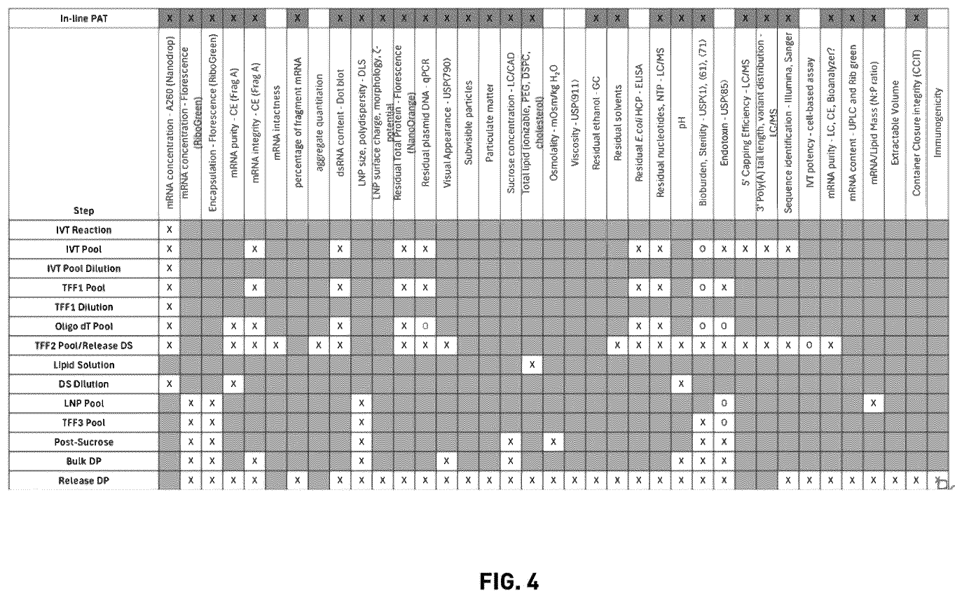

FIG. 4 illustrates an example of CQAs and the corresponding point of measurement for Ribonucleic acid (RNA)/Lipid nanoparticles (LNP) production. A machine learning model may predict trending data for a CQA of interest that is specific to a manufacturing process and specific to a unit operation for the in-line instrument in that manufacturing process. In many embodiments, the machine learning model may predict trending data for a CQA of interest based on a library of trending data for the CQA.

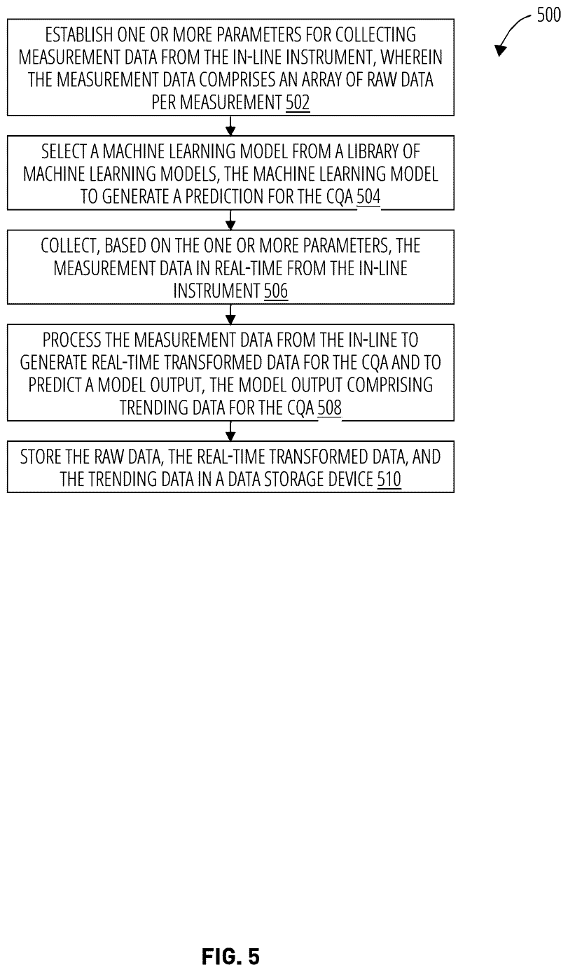

FIG. 5 illustrates a flowchart for a process 500 for a PAT management and operations system such as the PAT management and operations system 302 shown in FIG. 3 to establish monitoring for a Critical Quality Attribute (CQA) in real-time for an in-line instrument such as the in-line instrument 304 shown in FIG. 3. In block 502, process 500 establishes one or more parameters for collecting measurement data from the in-line instrument, wherein the measurement data comprises an array of raw data per measurement. In some embodiments, establishing one or more parameters for collecting measurement data from the in-line instrument may comprise establishing the one or more parameters specific to a manufacturing process and specific to each unit operation for the in-line instrument in that manufacturing process. In some embodiments, the PAT management and operations system may remotely control collection of raw measurement data from the in-line instrument such as starting collection of measurement data, stopping collection of measurement data, configuring parameters for collection of measurement data, and tracking an in-line instrument status for collection of measurement data such as ready, offline, configured, and/or the like.

In some embodiments, establishing one or more parameters may comprise commanding acquisition parameters or measurement configurations for the in-line instrument. In some aspects, the CQA for an in-line instrument comprises a volume, a concentration, or a mass.

The in-line instrument may include, for example, a spectrophotometer, a refractometer for measuring refractive index (RI), and/or a dynamic light scattering (DLS) instrument, e.g., for measuring multiangle light scattering (MALS). The spectrophotometer may be adapted to detect Raman, infrared (IR), including mid-IR (MIR), near-IR (NIR), far-IR (FarIR), ultraviolet (UV) and/or visible (VIS) wavelengths. The spectrophotometer may also be an ion mobility spectrophotometer (IMS). In some aspects, the in-line instrument may include one or more of a Raman spectrophotometer, an IR spectrophotometer, and/or a UV-VIS spectrophotometer, including a single instrument adapted to detect one or more of Raman, IR, UV, and VIS wavelengths. In some aspects, the in-line instrument may include a nuclear magnetic resonance (NMR) instrument. In some embodiments, the in-line instrument may comprise, for example, a Raman analyzer and a specific unit operation for the Raman analyzer may comprise in vitro transcription (IVT) reaction.

In some embodiments, the in-line instrument may include one of a mRNA concentration—A260 (nanodrop), a mRNA concentration—Florescence (RiboGreen), an encapsulation—Florescence (RiboGreen), a mRNA purity—CE (Frag A), a mRNA integrity—CE (Frag A), a mRNA intactness, a percentage of fragmentation mRNA, an aggregate quantitation, a dsRNA content—Dot blot, a LNP size, polydispersity—DLS, a LNP surface charge morphology ζ-potential, a residual total protein—florescence (NanoOrange), a residual plasmid DNA—qPCR, a visual appearance—USP<790>, a subvisible particles, a particulate matter, a sucrose concentration—LC/CAD, a total lipid (ionizable, PEG, DSPC, cholesterol), an osmolality—mOsm/kg H₂O, a viscosity—USP<911>, a residual solvents, a residual E. coli HCP—ELISA, a residual nucleotides NTP—LC/MS, a pH, a bioburden Sterility—USP<1><61><71>, an endotoxin—USP<85>, a 5′ Capping efficiency—LC/MS, a 3′ poly(A) tail length variant distribution LC/MS, a sequence identification—illumina Sanger, a IVT potency—cell-based assay, a mRNA purity—LC CE Bioanalyzer, a mRNA content—UPLC and Rib green, a mRNA/Lipid mass (N:P ratio), an extractable volume, a container closure integrity (CCIT), and an immunogenicity.

In block 504, process 500 selects a machine learning model from a library of machine learning models, the machine learning model may then transform the raw measurement data into a real-time CQA and may generate a prediction for the CQA such as trending data based on a library of trending data for the CQA. In some aspects, selection of the machine learning model may be based on the specific manufacturing process and may be specific to a unit operation for the in-line instrument in that manufacturing process.

In some aspects, the library of machine learning models comprises models for a set of specific unit operations for a process for manufacturing a pharmaceutical or biopharmaceutical product. In some aspects, the set of specific unit operations comprise one of a IVT reaction, IVT pool, IVT pool dilution, tangential flow filtration 1 (TFF1) pool, TFF1 dilution, Oligo dT pool, tangential flow filtration 2 (TFF2) pool/release DS, lipid solution, DS dilution, LNP pool, tangential flow filtration 3 (TFF3) pool, post-sucrose, bulk DP, and release DP.

In block 506, process 500 collects, based on the one or more parameters, the raw measurement data in real-time from the in-line instrument. For instance, the one or more parameters may identify a periodicity for collection of the measurement data such as every 5 minutes, every 3 minutes, every 2 minutes, every minute, or the like.

In block 508, process 500 processes the raw measurement data from the in-line to generate real-time transformed data for the CQA and to predict a model output. The model output may determine trending data for the CQA by, e.g., predicting the trending data for the CQA based on a library comprising multiple sets of trending data for the CQA. In some aspects, processing the raw measurement data may comprise enabling execution of Python models in a model execution web app or a locally executable model execution app. For example, the model execution may reside in a cloud server or a local server such as the computer 6000 shown in FIG. 6. The model execution web app may receive the raw measurement data from measurement sequencing and run or execute Python codes to process raw measurement data.

In some aspects, the model execution web app executes any Python models that can handle real-time data. The Python models may comprise pre-treatment methods including interpolating functions, derivation, and normalization; multivariate models including principal component analysis (PCA) and partial least square (PLS) regression; and hybrid models by combining mechanistic equations and multivariate models.

In block 510, process 500 stores the predicted trending data in a data storage device. The machine learning model may also store the raw measurement data and the transformed data (CQA) in a database or other data structure so that the raw measurement data and transformed data (or processed data) are available for visualization software and/or analytics software. In some aspects, storing the trending data in a data storage device comprises measurement sequencing, wherein measurement sequencing comprises storing the raw measurement data, the real-time transformed data, and the real-time trending data in a centralized database of PAT measurements and machine learning model outputs. In some embodiments, the data storage device comprises a centralized database that is accessible via a structured query language (SQL).

In some embodiments, the process 500 may further comprise displaying the real-time transformed data and real-time trending data on a display. In further embodiments, the process 500 may enable two-way communication between any in-line instrument that is capable of transferring data using Open Platform Communications Unified Architecture (OPC-UA) and Representational State Transfer Application Programming Interface (RestAPI).

According to some aspects, the raw data, the real-time transformed data, the trending data, and the machine learning models are auditable. For instance, the process 500 may maintain audit trails, version control, and security such as user authentication and user groups.

In further embodiments, the process 500 may further comprise enabling concurrent operation of multiple instruments and multiple models in real-time.

FIG. 6 illustrates an embodiment of a system 6000 such as a PAT management and operations system 302 shown in FIG. 3. The system 6000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., a smart phone or other cellular phone, an external storage device, or the like. Further embodiments implement larger scale server configurations. In other embodiments, the system 6000 may have a single processor with one core or more than one processor. Note that the term “processor” refers to a processor with a single core or a processor package with multiple processor cores.

As shown in FIG. 6, system 6000 comprises a motherboard 6005 for mounting platform components. The motherboard 6005 is a point-to-point interconnect platform that includes a first processor 6010 and a second processor 6030 coupled via a point-to-point interconnect 6056 such as an Ultra Path Interconnect (UPI). In other embodiments, the system 6000 may be of another bus architecture, such as a multi-drop bus. Furthermore, each of processors 6010 and 6030 may be processor packages with multiple processor cores including processor core(s) 6020 and 6040, respectively. While the system 6000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 6010 and the chipset 6060. Some platforms may include additional components and some platforms may only include sockets to mount the processors and/or the chipset.

The first processor 6010 includes an integrated memory controller (IMC) 6014 and point-to-point (P-P) interconnects 6018 and 6052. Similarly, the second processor 6030 includes an IMC 6034 and P-P interconnects 6038 and 6054. The IMC's 6014 and 6034 couple the processors 6010 and 6030, respectively, to respective memories, a memory 6012 and a memory 6032. The memories 6012 and 6032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 6012 and 6032 locally attach to the respective processors 6010 and 6030. In other embodiments, the main memory may couple with the processors via a bus and shared memory hub.

The processors 6010 and 6030 comprise caches coupled with each of the processor core(s) 6020 and 6040, respectively. In the present embodiment, the processor core(s) 6020 of the processor 6010 include a PAT management and operations logic 6026 such as the PAT management and operations system 302 shown in FIG. 3. The PAT management and operations logic 6026 may represent circuitry configured to perform configuration, modelling, modeling output within the processor core(s) 6020 or may represent a combination of the circuitry within a processor and a medium to store all or part of the functionality of the PAT management and operations system 6026 in memory such as cache, the memory 6012, buffers, registers, and/or the like. In several embodiments, the functionality of the PAT management and operations logic 6026 resides in whole or in part as code in a memory such as the PAT management and operations logic 6096 in the data storage unit 6088 attached to the processor 6010 via a chipset 6060 such as the PAT management and operations system 302 shown in FIG. 3. The functionality of the PAT management and operations logic 6026 may also reside in whole or in part in memory such as the memory 6012 and/or a cache of the processor. Furthermore, the functionality of the PAT management and operations logic 6026 may also reside in whole or in part as circuitry within the processor 6010 and may perform operations, e.g., within registers or buffers such as the registers 6016 within the processor 6010, registers 6036 within the processor 6030, or within an instruction pipeline of the processor 6010 or the processor 6030.

In other embodiments, more than one of the processors 6010 and 6030 may comprise functionality of the PAT management and operations logic 6026 such as the processor 6030 and/or the processor within the deep learning accelerator 6067 coupled with the chipset 6060 via an interface (I/F) 6066. The I/F 6066 may be, for example, a Peripheral Component Interconnect-enhanced (PCI-e).

The first processor 6010 couples to a chipset 6060 via P-P interconnects 6052 and 6062 and the second processor 6030 couples to a chipset 6060 via P-P interconnects 6054 and 6064. Direct Media Interfaces (DMIs) 6057 and 6058 may couple the P-P interconnects 6052 and 6062 and the P-P interconnects 6054 and 6064, respectively. The DMI may be a high-speed interconnect that facilitates, e.g., eight Giga Transfers per second (GT/s) such as DMI 3.0. In other embodiments, the processors 6010 and 6030 may interconnect via a bus.

The chipset 6060 may comprise a controller hub such as a platform controller hub (PCH). The chipset 6060 may include a system clock to perform clocking functions and include interfaces for an I/O bus such as a universal serial bus (USB), peripheral component interconnects (PCIs), serial peripheral interconnects (SPIs), integrated interconnects (12Cs), and the like, to facilitate connection of peripheral devices on the platform. In other embodiments, the chipset 6060 may comprise more than one controller hub such as a chipset with a memory controller hub, a graphics controller hub, and an input/output (I/O) controller hub.

In the present embodiment, the chipset 6060 couples with a trusted platform module (TPM) 6072 and the unified extensible firmware interface (UEFI), BIOS, Flash component 6074 via an interface (I/F) 6070. The TPM 6072 is a dedicated microcontroller designed to secure hardware by integrating cryptographic keys into devices. The UEFI, BIOS, Flash component 6074 may provide pre-boot code.

Furthermore, chipset 6060 includes an I/F 6066 to couple chipset 6060 with a high-performance graphics engine, graphics card 6065. In other embodiments, the system 6000 may include a flexible display interface (FDI) between the processors 6010 and 6030 and the chipset 6060. The FDI interconnects a graphics processor core in a processor with the chipset 6060.

Various I/O devices 6092 couple to the bus 6081, along with a bus bridge 6080 which couples the bus 6081 to a second bus 6091 and an I/F 6068 that connects the bus 6081 with the chipset 6060. In one embodiment, the second bus 6091 may be a low pin count (LPC) bus. Various devices may couple to the second bus 6091 including, for example, a keyboard 6082, a mouse 6084, communication devices 6086 and a data storage unit 6088 that may store code such as the simulator logic circuitry 6096. Furthermore, an audio I/O 6090 may couple to second bus 6091. Many of the I/O devices 6092, communication devices 6086, and the data storage unit 6088 may reside on the motherboard 6005 while the keyboard 6082 and the mouse 6084 may be add-on peripherals. In other embodiments, some or all the I/O devices 6092, communication devices 6086, and the data storage unit 6088 are add-on peripherals and do not reside on the motherboard 6005.

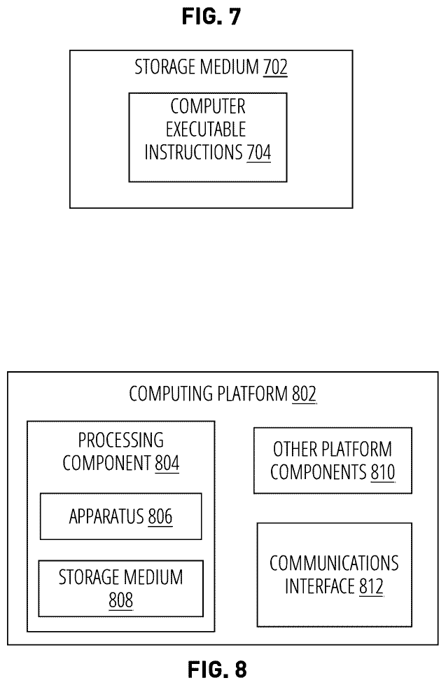

FIG. 7 illustrates an example of a storage medium 702 to store code for simulator logic circuitry such as the PAT management and operations logic 6096 in the data storage 6088 shown in FIG. 6. Storage medium 702 may comprise an article of manufacture. In some examples, storage medium 702 may include any non-transitory computer readable medium or machine readable medium, such as an optical, magnetic or semiconductor storage. Storage medium 702 may store various types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 8 illustrates an example computing platform 802 such as the system 6000 shown in FIG. 6. In some examples, as shown in FIG. 8, computing platform 802 may include a processing component 804, other platform components or a communications interface 812. According to some examples, computing platform 802 may be implemented in a computing device such as a server in a system such as a data center or server farm that supports a manager or controller for managing configurable computing resources as mentioned above. Furthermore, the communications interface 812 may comprise a wake-up radio (WUR) and may be capable of waking up a main radio of the computing platform 802.

According to some examples, processing component 804 may execute processing operations or logic for apparatus 806 described herein such as the PAT management and operations software 302 illustrated in FIG. 3. Processing component 804 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 808, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 810 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 812 may include logic and/or features to support a communication interface. For these examples, communications interface 812 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 802 may be part of a computing device that may be, for example, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 802 described herein, may be included or omitted in various embodiments of computing platform 802, as suitably desired.

The components and features of computing platform 802 may be implemented using any combination of discrete circuitry, ASICs, logic gates and/or single chip architectures. Further, the features of computing platform 802 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the computing platform 802 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

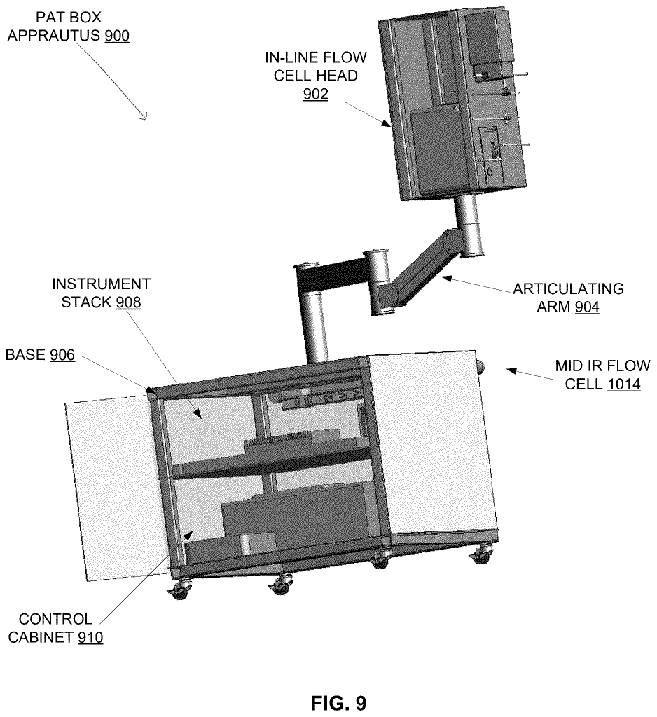

FIG. 9 illustrates an embodiment of a PAT Box apparatus 900 where a weighted base 906 houses a PAT instrument stack and a PAT control cabinet. An articulating arm 904 connects the weighted base to an in-line flow cell head 902 containing a set of flow cells customized for process-specific in-line instruments and their respective transmitters. The PAT instrument stack contains the in-line instrument computers.

The PAT control cabinet contains electrical I/O, and optionally a programmable logic computer (PLC) or other computer. In many embodiments, the control cabinet includes a human machine interface (HMI) such as a display, touch screen, and/or the like, a controller such as an advanced process controller (APC), and a network switch (such as an ethernet switch), a fiber media converter, and/or other networking hardware, for connecting to a manufacturing network and/or a digital control infrastructure that may include e.g., a digital twin, a simulator, process models, and a Knowledge Hub which may integrate facility data with process data, including historical process data and clinical data, as well as data from the digital twin and/or simulator.

The controller may comprise one or more computers such as the computer 6000 shown in FIG. 6 and data storage devices such as the data storage device 6088 shown in FIG. 6 to store and execute PAT software or code of a PAT management and operations system such as the PAT management and operations system 112 and the PAT management and operations logic 6096 (software or code). In many embodiments, the one or more data storage devices may comprise a library of models including one or more models for each instrument in the PAT instrument stack of the PAT Box apparatus 900 to measure, collect, and store raw measurement data. In some embodiments, one or more of the models in the one or more data storage devices may pre-process, process, and/or transform raw measurement data from the instruments in the PAT instrument stack. In other embodiments, the one or more of the models may reside and/or execute in a remote computer system such as a cloud system for a pharmaceutical or biopharmaceutical manufacturing process.

The PAT Box apparatus 900 may also include tubing, valves and pumps configured to control the flow of process fluid between an external vessel, a unit operation, and/or a recirculation loop and the flow cells. In operation, one or more valves and/or pumps may be controlled by a controller of the PAT control cabinet in accordance with one or more predetermined criteria. The PAT Box apparatus 900 may also include fluid inlet and outlet ports, additional ports for sensors and/or probes and one or more sample ports for data acquisition and material analysis. Also provided is a system including a PAT Box apparatus 900 and associated mechanical and digital infrastructure.

The in-line flow cell head 902 is adapted to add or remove flow cells as needed to customize the PAT Box apparatus 900 for use with a particular unit operation. The flow cell head may also include one or sample ports and/or cuvettes. This versatility allows for the incorporation of data from a variety of different in-line, at-line, and off-line process analytical instruments. Exemplary process analytical instruments may include spectrophotometers, refractometers, dynamic light scattering instruments, nuclear magnetic resonance (NMR) instruments, liquid chromatography-mass spectroscopy (LC-MS) instruments, and the like. Thus, in one aspect, the PAT Box apparatus 900 may be configured to measure and process data from one or more spectroscopic instruments, such as instruments for detecting Raman, infrared (IR), and ultraviolet (UV) spectra. In another aspect, the PAT Box apparatus 900 may be configured to measure and process data from both a spectroscopic instrument and one or more additional instruments such as a refractometer for measuring refractive index (RI), and/or a dynamic light scattering (DLS) instrument, e.g., for measuring multiangle light scattering (MALS), which may also be referred to as a MALS detector. In an aspect, the PAT Box apparatus 900 is configured to support an at-line process analytical instrument, optionally wherein the at-line process analytical instrument is a high performance liquid chromatography (HPLC) instrument, a flow cytometer, a capillary electrophoresis (CE) instrument, a mass spectrophotometer, an osmometer, a UV-VIS spectrophotometer, a fluorometer, a light scattering detector, or a luminometer.

The articulating arm 904 advantageously brings the in-line flow cells close to the unit operation or vessel in the biomanufacturing process. In some aspects, a recirculation line may be used to pull process material from the unit operation for passing through the in-line flow heads, sensors, and/or probes of the head 902. Use of an articulating arm 904 allows for a shorter recirculation line and smaller hold-up volumes in the line compared to what would be required if the apparatus was located at a more distant site from the unit operation. The articulating arm 904 also allows for optimal positioning and increased mobility around the manufacturing equipment while decreasing the overall footprint needed for the PAT Box apparatus.

Some configurations of the PAT Box apparatus 900 may require fewer process analytic technologies or technologies that have smaller components. Combined with an articulating arm, this may create an unstable top-heavy configuration unless properly mitigated with a weighted base. Thus, the weighted base provides an additional functional enhancement to increase safety to equipment and personnel.

In addition, some configurations of the PAT Box apparatus 900 may include built-in environmental protections such as electromagnetic frequency (EMF) shielding, vibrational dampening, shock absorption, and temperature control. For example, where the PAT Box apparatus 900 includes a Mid IR and NMR component, EMF shielding can be utilized to protect the instrument from interference that could cause failure or inaccurate measurement. As another example, where a PAT Box apparatus 900 includes a DLS component, vibrational dampeners and shock absorbers may be included. Temperature control strategies may include one or more air fans or liquid cooling using convective heat transfer.

In aspects, the weight base comprises an automated leveling system.

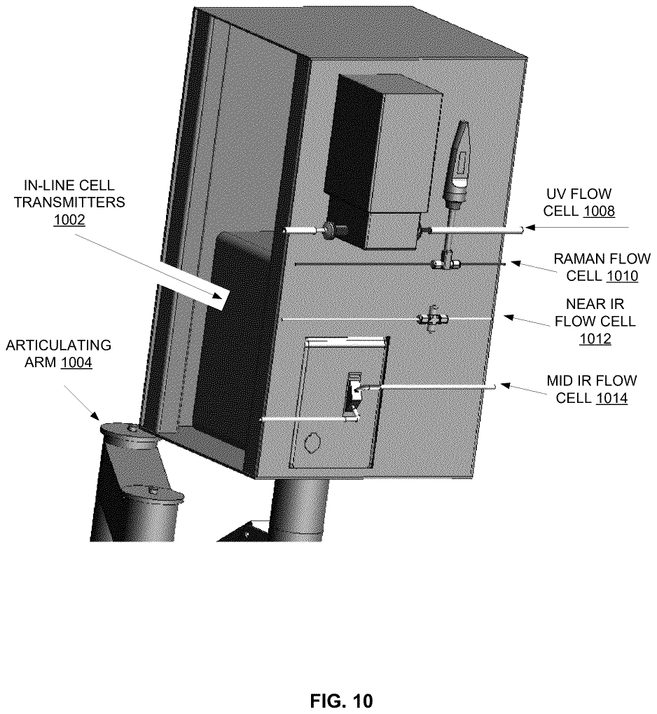

FIG. 10 is an inset of the in-line flow cell head 902, showing exemplary flow cells, a UV flow cell 1008, a Raman flow cell 1010, a Near IR flow cell 1012, and a Mid IR flow cell 1014, secured to the flow cell head 902. The interior of the head 902 contains any necessary transmitters 1002 for the in-line flow cells. This configuration allows for the flow cells to be positioned close to a unit operation or vessel recirculation loop for fluid connection in-line to a biomanufacturing process.

In aspects, the PAT Box apparatus may be configured to measure and process data from one or more of a spectrophotometer, a refractometer, a multiangle light scattering (MALS) detector, and/or a DLS instrument. In aspects, the spectrophotometer may detect Raman spectra, including Fourier Transform Raman Spectroscopy (FR-Raman), infrared (IR), including mid-IR (MIR), near-IR (NIR), far-IR (FarIR), or ultraviolet (UV) spectra and/or visible (VIS) wavelengths. In aspects, the spectrophotometer may also include an ion mobility spectrophotometer (IMS).

In aspects, the instrument stack of the PAT Box apparatus includes two or more spectroscopic instruments selected from a Raman spectrophotometer, a mid-infrared (IR) spectrophotometer, a near-IR spectrophotometer, and an ultraviolet-visible (UV-VIS) spectrophotometer.

In aspects, the instrument stack of the PAT Box apparatus includes a Raman spectrophotometer, a mid-infrared (IR) spectrophotometer, a near-IR spectrophotometer, and a UV-VIS spectrophotometer. In aspects, the PAT Box apparatus includes a Raman spectrophotometer, a mid-infrared (IR) spectrophotometer, a near-IR spectrophotometer, a UV-VIS spectrophotometer and a multiangle light scattering (MALS) detector.

In aspects, the instrument stack of the PAT Box apparatus includes a refractometer.

In aspects, the instrument stack of the PAT Box apparatus includes an ion mobility spectrophotometer (IMS).

In aspects, the instrument stack of the PAT Box apparatus includes a nuclear magnetic resonance (NMR) instrument.

Table 1 includes an example of a list of instruments with an integration status for some embodiments of the PAT management and operations system such as the PAT management and operations logic 6096 shown in FIG. 6. Table 1 describes an integration status for the example list of instruments into the PAT management and operations logic (code or software). Fully integrated status means that users can automate instruments fully from a user interface of the PAT management and operations logic, design orchestration to acquire measurements, and obtain data in real-time for visualization or further processing within the PAT management and operations logic to present a real-time visualization of, e.g., CQAs for the process, optionally including trending data for the CQAs. An integration process is ongoing for Avantes AvaSpec-Mini-NIR and Repligen CTech™ FlowVPX® System. And an integration process will start in the near future for Magritek Spinsolve 80 ULTRA.

TABLE 1
integration status for the instruments into
PAT management and operations logic

| | | | | Integration |
|---|---|---|---|---|
| No. | Company | Product | Technology | status |
| 1 | Thermo | MarqMetrix | Raman | Fully |
| | Fisher | all-in-one | spectroscopy | integrated |
| | Scientific | | | |
| 2 | IRUBIS | MONIPA | Mid-infrared (MIR) | Fully |
| | | | spectroscopy | integrated |
| 3 | Waters | DAWN ™ - | Multi-angle light | Fully |
| | Corporation | MALS | scattering (MALS) | integrated |
| | | Instrument | | |
| 4 | InProcess- | NanoFlowSizer | Dynamic light | Fully |
| | LSP | | scattering (DLS) | integrated |
| 5 | Avantes | AvaSpec-Mini- | Near-infrared (NIR) | Integration |
| | | NIR | spectroscopy | ongoing |
| 6 | Repligen | CTech ™ | Variable pathlength | Integration |
| | | FlowVPX ® | ultraviolet-visible | ongoing |
| | | System | (UV-VIS) | |
| | | | spectroscopy | |
| 7 | Magritek | Spinsolve 80 | Nuclear magnetic | To be |
| | | ULTRA | resonance (NMR) | integrated |
| | | | spectroscopy | |

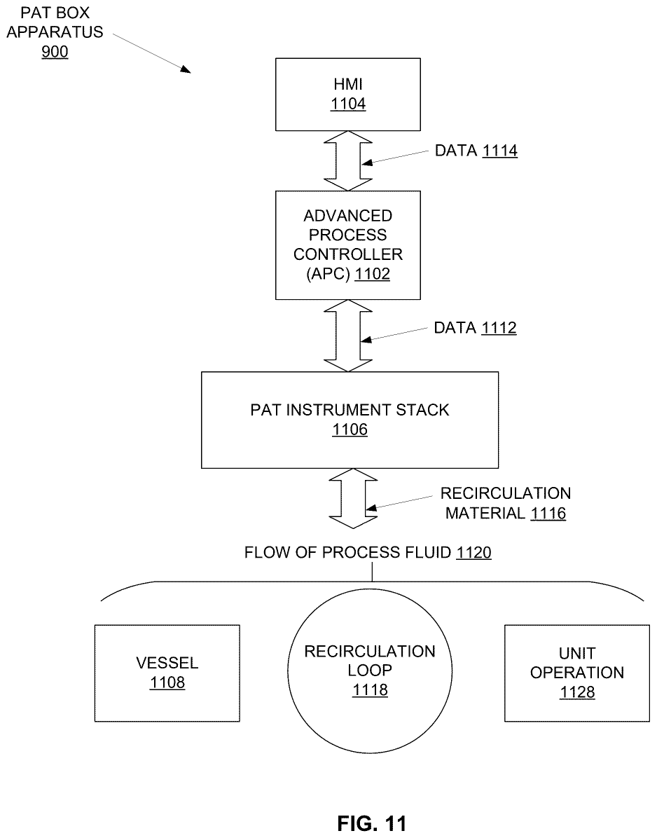

FIG. 11 schematically illustrates the flow of data and process fluid in accordance with different aspects of a PAT Box apparatus 900 in operation. Shown are the human machine interface (HMI) 1104 and a controller, e.g., an Advanced Process Controller (APC) 1102 of the PAT Control Cabinet 910. Also illustrated is the flow of data 1112 and 1114 between the HMI 1104 and APC 1102 and the PAT Instrument Stack 1106. Also shown is the flow of process fluid 1120 as Recirculation Material 1116 between the flow cells, sensors, and/or probes of the PAT instrument stack 1106 and an external vessel 1108, a recirculation loop 1118, or a unit operation 1128.

In an illustrative example of real time release testing (RTRT), the vessel 1108 may be fluidly connected with a process fluid stream between a first unit operation and a second unit operation in a biopharmaceutical manufacturing process. In operation, a volume of the process fluid stream enters the vessel 1108 from the first unit operation and recirculates between the vessel 1108 and the flow cells, sensors and/or probes of the PAT Box apparatus 900 while data 1112 and 1114 are obtained. Data 1112 obtained from the PAT instruments in the PAT instrument stack 1106 is analyzed by the APC 1102 operating in conjunction with an appropriate model to determine if the product fluid stream satisfies a predetermined criteria, which may relate to, for example, a CQA of the product. If the criteria is satisfied, the controller executes a set of instructions to release the volume of process fluid from the first unit operation to the second unit operation in the process.

The HMI 1104 may include a digital display comprising a dashboard including a visual output of model results and a user interface for control of individual sensors and probes. The user interface may include a touch screen, a display, a keyboard, a mouse or other pointer, a printer, a wired or wireless network connection to a network of process data storage and servers, and/or the like. In aspects, the HMI 1104 may be in the form of a computer, for example a laptop computer or a programmable logic computer (PLC).

As discussed above, in aspects, the controller may include at least four software layers of the PAT management and operations logic. The at least four software layers include a data acquisition layer, a process scheduling layer, a deviation handling layer, and a real-time execution layer. In aspects, the software layers execute a set of programmable instructions. In aspects, the programmable instructions may be programmed in a language selected from C, Python Java, JavaScript, Perl, Tcl, or Smalltalk.

In aspects, the controller includes a distributed control system (DCS) including a host computer performing optimization algorithms and advanced control strategies and one or more proportional integral derivative (PID) controllers performing device level controls. The system may also include control units performing regulatory level control functions, such as PID algorithms, and may also include data gathering and extraction capabilities. The system may also include data storage devices to store process data for control and process analytics. Also included is software to communicate and interact with controllers, inputs, and outputs.

In aspects, the APC 1102 and HMI 1104 may be situated in a cabinet physically separated from the PAT Instrument Stack 1106.

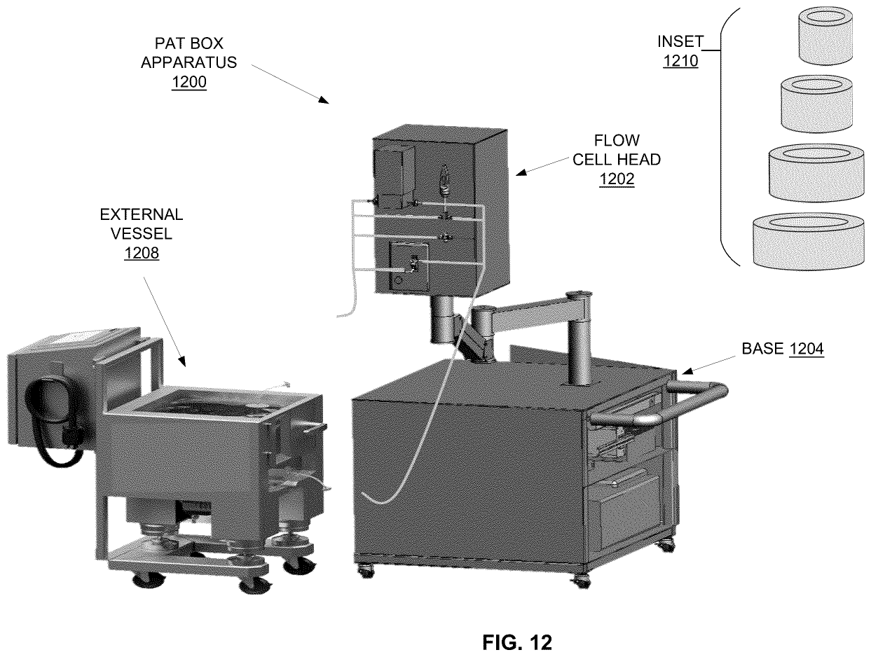

FIG. 12 illustrates a configuration of a PAT Box apparatus 1200 situated next to an external vessel 1208 which may be connected to a unit operation of a manufacturing process, or may be situated in-line between two unit operations of the process. The figure illustrates tubing connecting the flow cells of the head 1202 to the external vessel 1208. In other aspects, where the external vessel 1208 is absent, the tubing may connect directly to a unit operation of the process. The external vessel 1208 may be any type of vessel, tank or bag. The external vessel 1208 may include a plurality of ports, including IO ports for data transfer between multiple control panels and/or software. In aspects, the external vessel 1208 incorporates one or more analytical detectors, sensors and/or probes including for example, a conductivity sensor, a temperature sensor, and/or pH probe. The external vessel 1208 may have a volume of from 0.100 to 5000 liters, from 0.500 to 1000 liters, or from 2 to 500 liters. The list of range of volumes is not intended to be limiting and can fall below 0.1 liters and above 5000 liters.

In an advantageous aspect of its versatility and modularity, a PAT Box apparatus 1200 may be configured with a custom set of flow cells and optional sensors or probes, along with associated tubing and valves adapted for a particular set of process analytic instruments to meet the needs of a particular manufacturing process. The set of flow cells, tubing, valves and optional sensors or probes adapted for a specific use may be referred to herein collectively as a flow kit.

The tubing accompanying a flow kit may be adapted for various purposes such as temperature control and/or flow rate. In aspects, the temperature control capabilities may derive from insulated tubing and/or a jacketed stainless steel tube with temperature control fluid. In the latter context, the outer tube flows temperature controlled fluid that is regulated by a temperature control unit (TCU). The inner tube contains the product flow (fluid) stream and temperature control fluid passes around the product flow stream thereby transporting heat towards or heat away from the product flow stream via convection. The temperature control fluid that transports heat towards or away from the product flow stream then returns to the TCU to be refreshed towards the temperature set-point. This aspect may be useful, for example, where product is temperature sensitive and/or temperature variation can cause fouling of the tubing or sensors.

The tubing accompanying a flow kit may also or alternatively be adapted to produce a particular flow rate through the flow cell(s). In FIG. 12, the inset 1210 illustrates the wide range of flow rate capabilities that may be obtained using tubing having various different inner diameters. For example, specific flow rates, pressure profiles, or Reynolds number conditions can be attained inside the tubing or flow cell by either increasing or decreasing the flow rate via the in-line flow cell tubeset pump, and/or by increasing or decreasing the tubing inner diameter. In aspects, the flow rate may range from 0.0-50.0 L/min and the inner diameter of the tubing may range from 1/32 inch to ½ inch. In aspects, the inner diameter of the tubing may be 1/32 inch, ⅛ inch, ¼ inch, or ½ inch, but is not limited to these sizes.

Also provided are additional flow kits including a calibration flow kit. The calibration flow kit is used to calibrate in-line flow cell instrumentation and/or validate the operational and performance of the in-line flow cell instruments. For example, a Raman in-line flow cell may need to be tested to confirm the laser intensity is within range and the spectral readings are sending back the range and intensity as expected for a certain reference standard such as ethanol. This calibration activity might be performed before first use, such as during an installation, operation, and/or performance qualification or for routine preventative maintenance activities. After completion of calibration or validation activities, the calibration flow kit may be removed and replaced with a process flow kit. In other aspects, the PAT management and operations system may be configured, e.g., valves, tubing, etc, to perform automated calibrations of one or more of the instruments in the PAT instrument stack, prior to first use, periodically during use, on-demand via a user interface of the HMI, between movement of volumes of process fluid between unit operations, based on input from one or more models for the instruments, and/or in accordance with one or more schedules for calibration. For instance, one or more models may monitor calibration of one or more instruments and suggest via the HMI or automatically cause an instrument calibration to be performed at various stages of the process.

Also provided is a cleaning in place (CIP) flow kit. Where in-line flow cells are permanently attached to their internal components or instrumentation and cannot be made single use, the flow cells may need to be cleaned and sanitized, either before use or after becoming fouled. The CIP flow kit includes “Y” connectors upstream and downstream of the flow cells so that cleaning solution can flow through the flow cells.

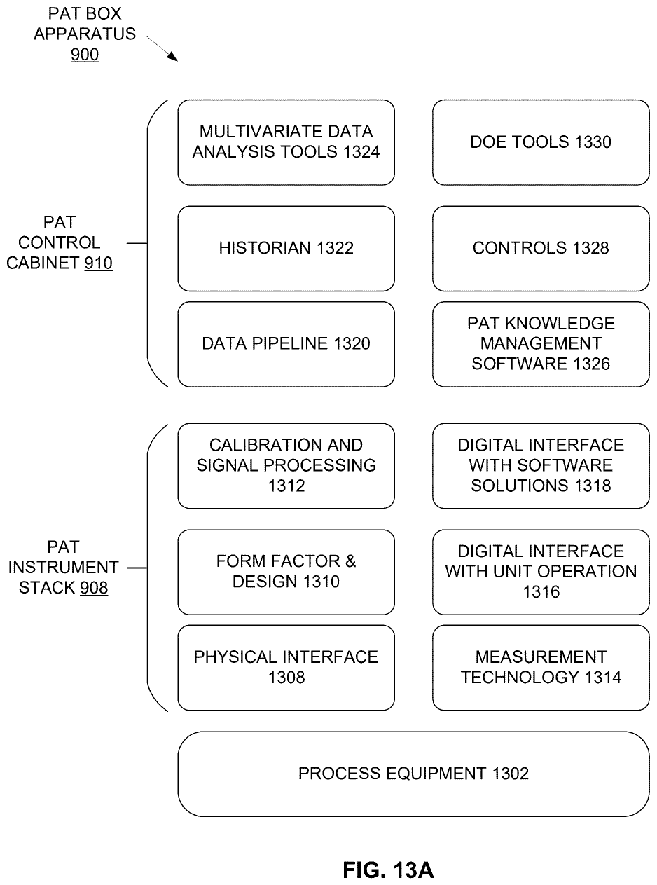

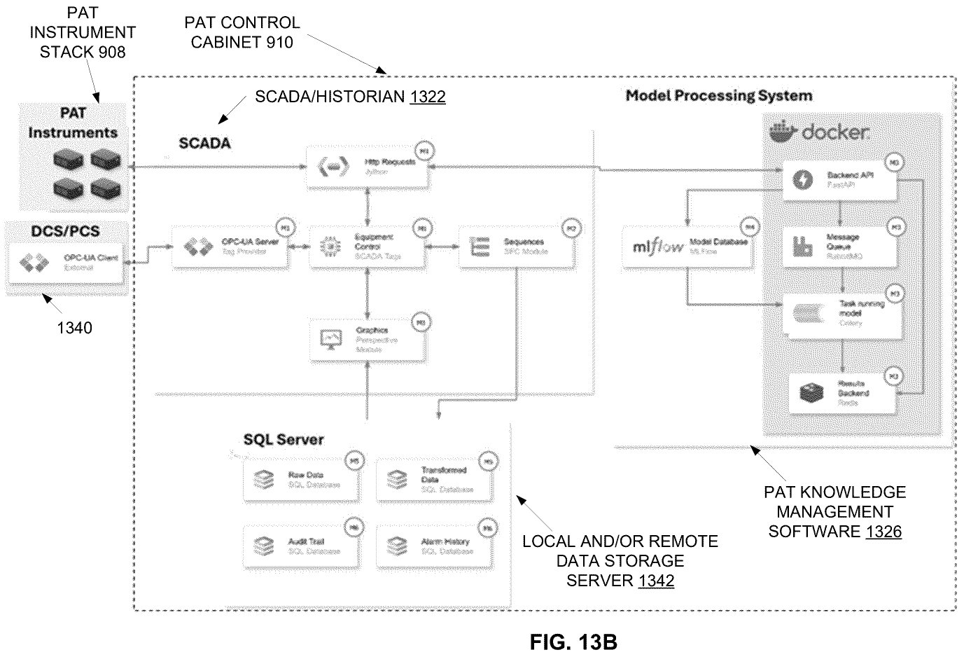

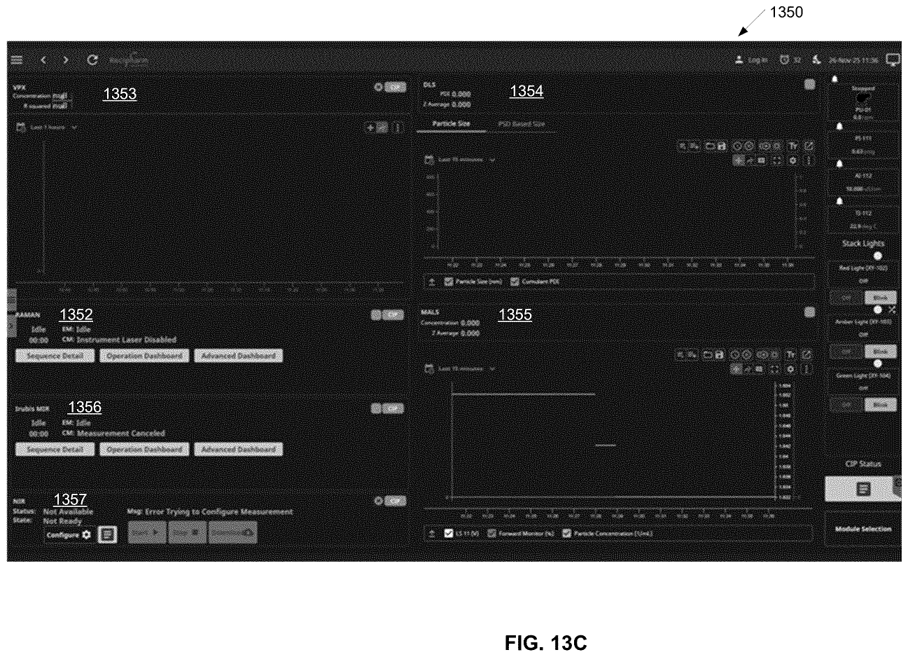

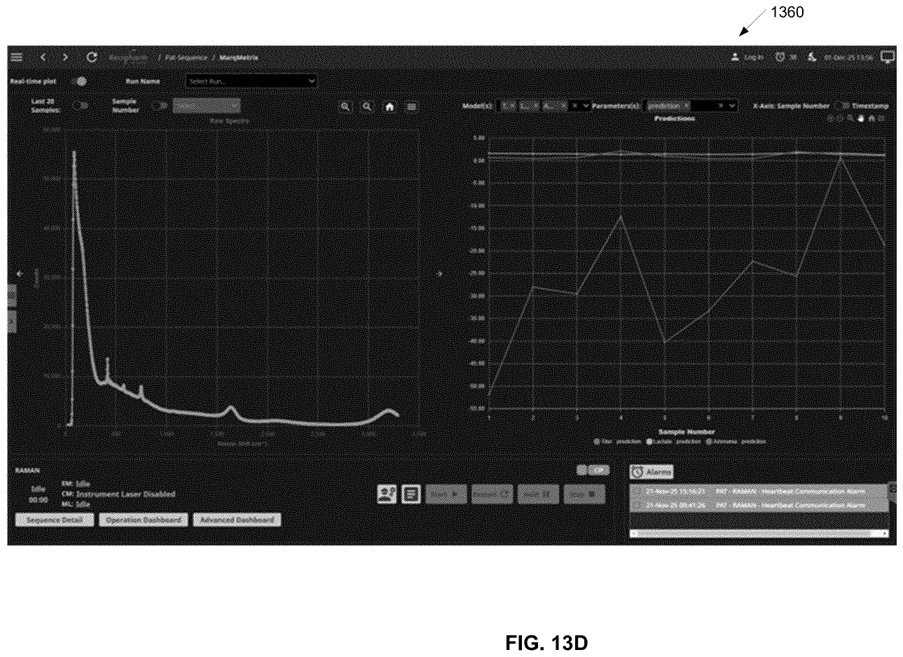

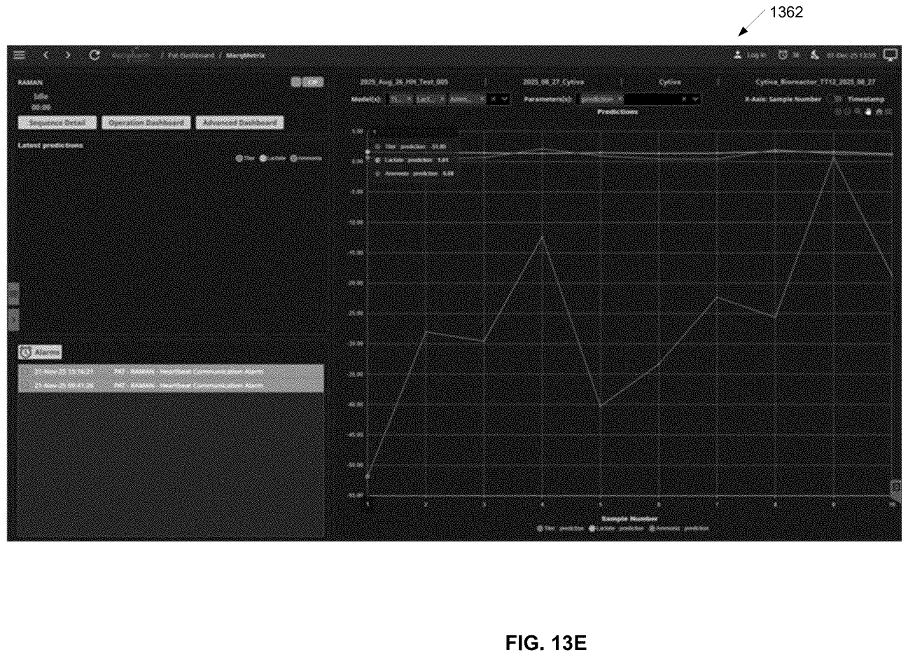

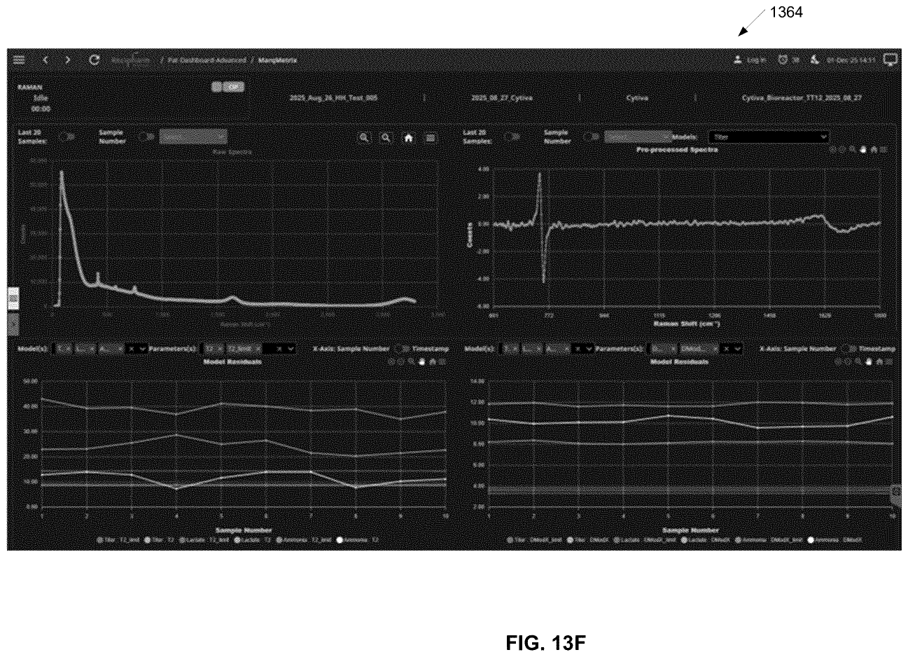

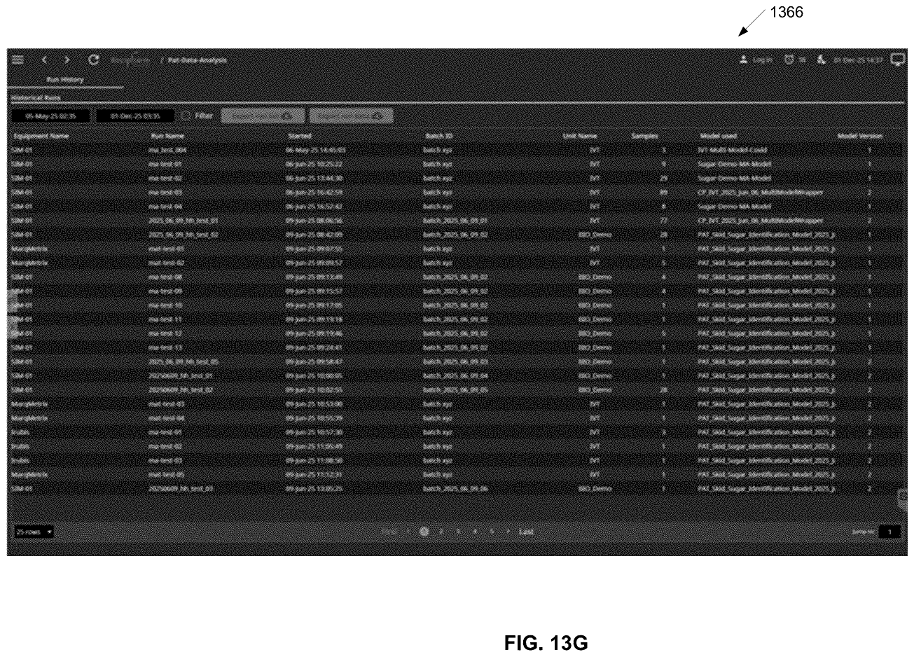

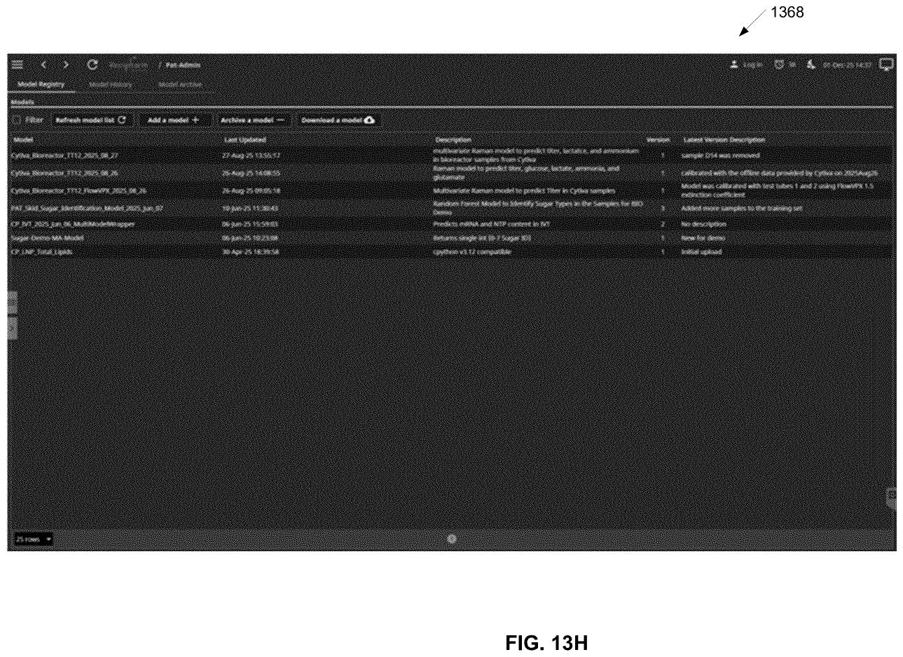

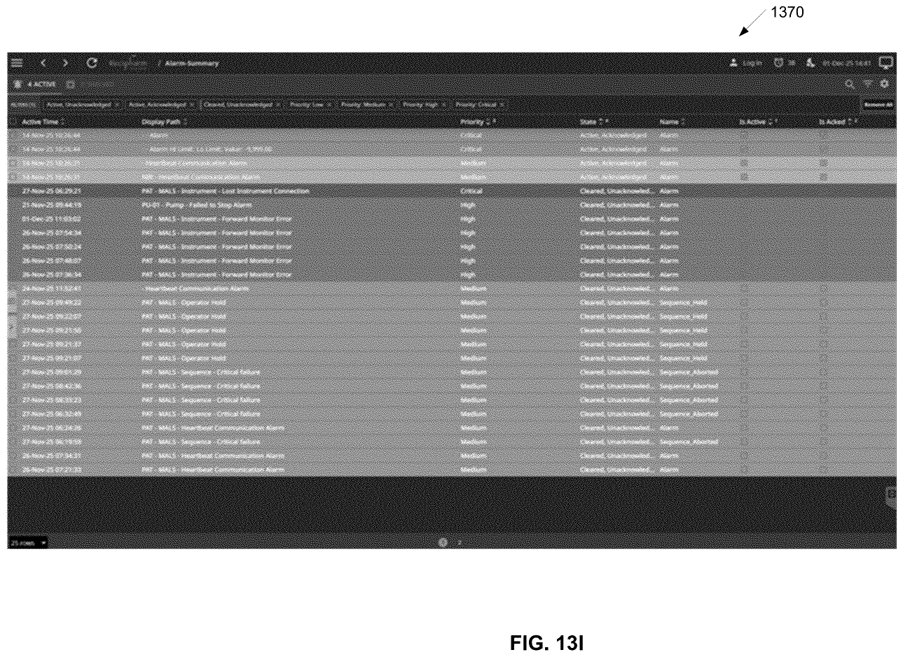

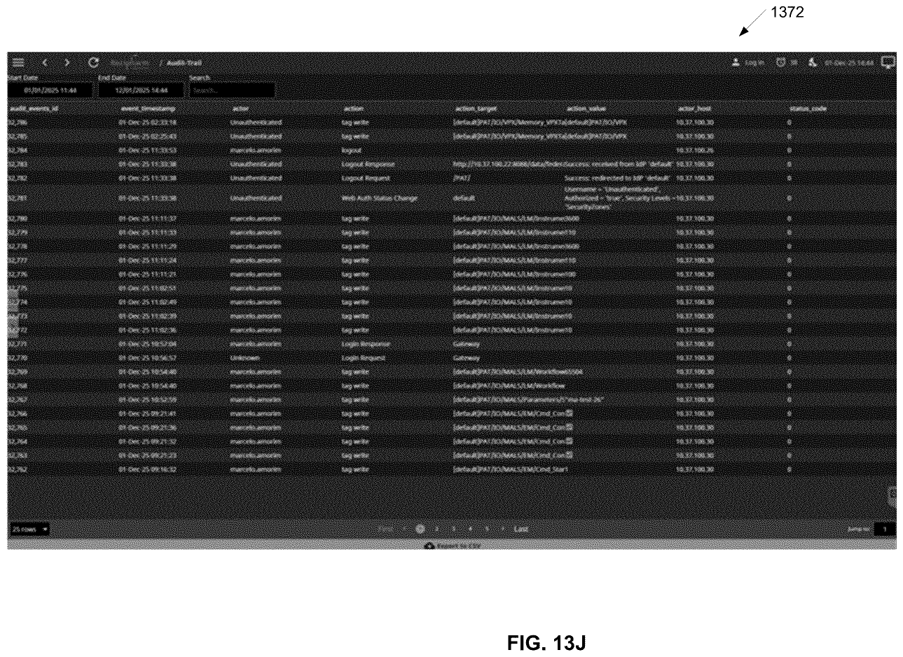

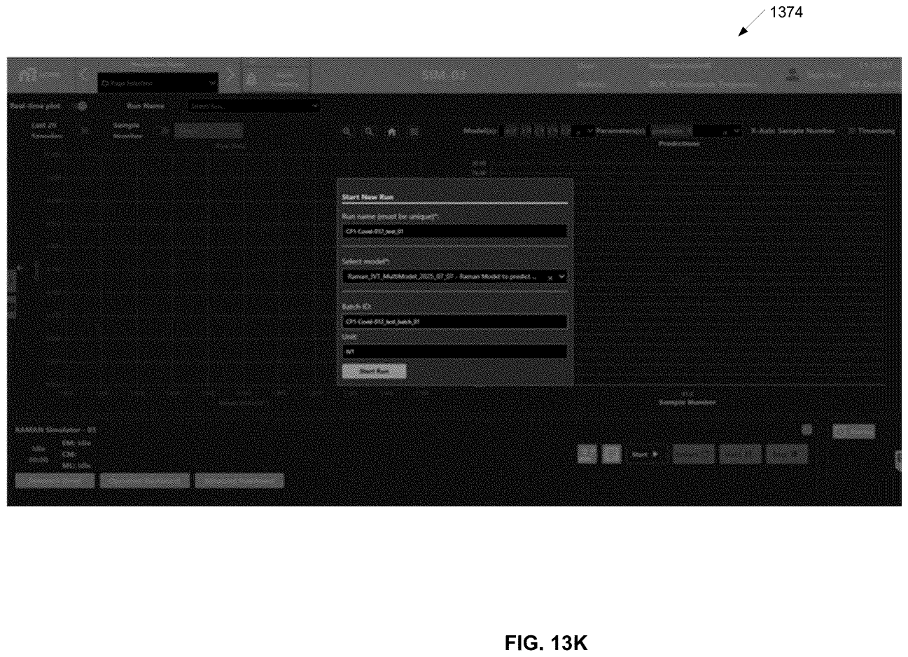

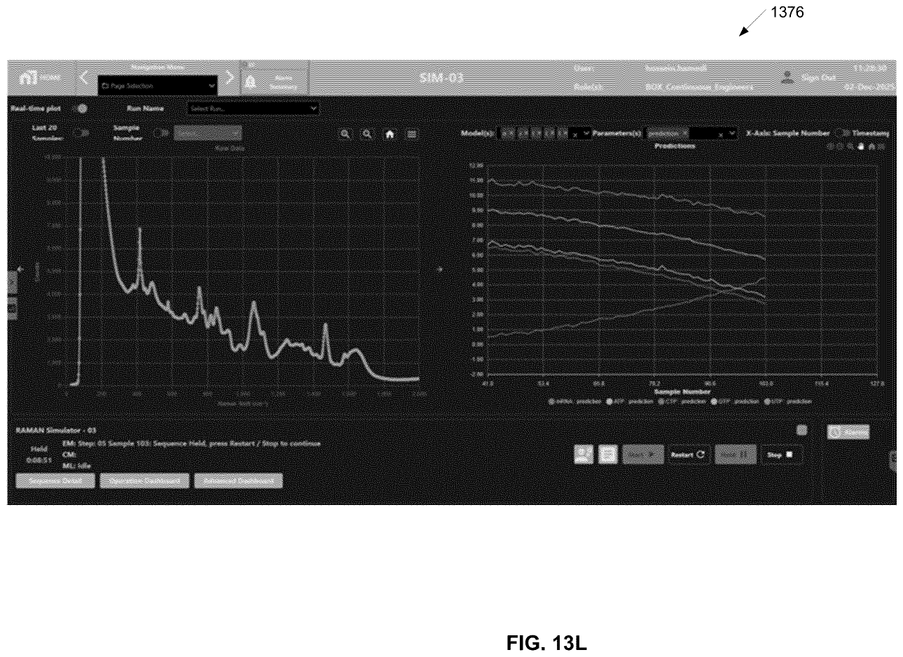

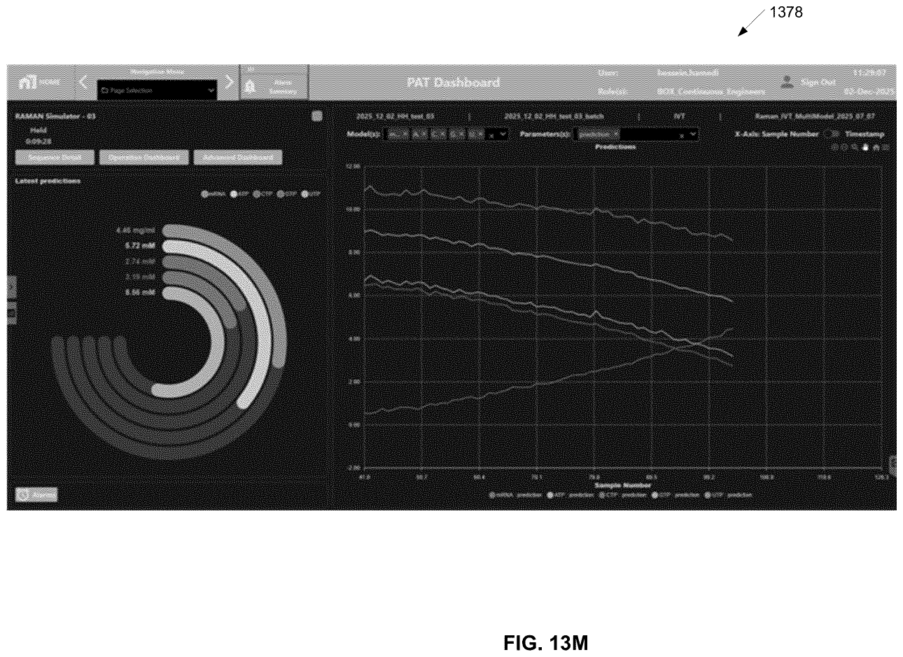

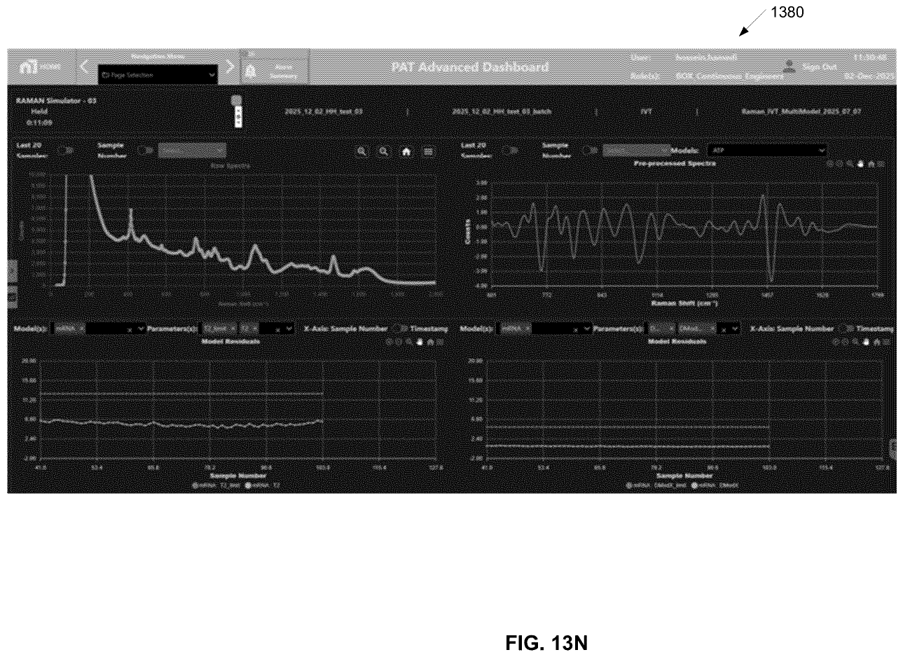

FIG. 13A schematically illustrates an embodiment of a PAT Box apparatus 900 as described herein. The figure illustrates the modular framework of the apparatus 900. Shown is the PAT instrument stack 908 and the PAT control cabinet 910 of the apparatus 900 which integrate with process equipment 1302.

While the FIGS. 13A-13N illustrate PAT management and operations logic within the PAT control cabinet 910 of a PAT Box apparatus 900, embodiments are not limited to this configuration. For instance, the PAT management and operations logic may reside in the PAT Box apparatus, on a remote computer or server, on a cloud server, in remote data storage accessible by a local or remote computer or server, and/or the like. In some embodiments, for example, the PAT management and operations logic may be accessed via a web browser by a controller in the PAT control cabinet 910 and may execute on a remote server. The remote server may display the user interface of the PAT management and operations logic in a local display of the PAT Box apparatus 900 and/or on a remote display. In some embodiments, all functionality of PAT management and operations logic can be performed via a remote computer or server through a wired or wireless network connection with the PAT Box apparatus 900. In such embodiments, the PAT Box apparatus 900 may comprise and execute a client software layer to facilitate remote management and control of the PAT Box apparatus 900 by the PAT management and operations logic including, e.g., instrument calibration and configuration, scheduling measurements by instruments, selecting and executing models for instruments, pretreating measurement data, processing measurement data, transforming measurement data, storing measurement data, and visualizing measurement data and trending data on one or more local and/or remote displays.

In other embodiments, the PAT management and operations logic may reside at least partially in local data storage of the PAT Box apparatus 900 and at least partially in remote data storage accessible and executable by a remote server. In such embodiments, some software layers of the PAT management and operations logic may execute on a controller of the PAT Box apparatus 900 and some software layers may execute on the remote server.

In the present embodiment, the PAT control cabinet 910 includes communications, data, and analysis (CDA) software of the PAT management and operations logic. In aspects, the PAT control cabinet includes computational modeling software such as multivariate data analysis tools 1324 which permit real-time insight and response via accessible/static and dynamic model building. In aspects, also included is design of experiments (DOE) software, a historian 1322, process controls 1328, and a data pipeline 1320. Also included is PAT knowledge management software 1326 which provides automated data collection, extraction, harmonization and storage as well as multivariate data analysis (MVDA) capabilities, technology transfer and batch record integration. In aspects, an application programming interface (API) adapter may be included to integrate with existing in-line, off-line, on-line, and/or at-line process analytic technology instruments. In operation, the PAT Knowledge Management software 1326 processes raw data, including using available models as needed to convert the data, e.g., spectra, into appropriate product attributes, including critical quality attributes (CQAs). In aspects, software tools of the PAT control cabinet 910 provide easy to understand outputs having clear direction that may be integrated into process controls.

The PAT instrument stack 1304 includes various modules adapted to be quickly integrated into a manufacturing process in a “plug and play” fashion. In aspects, the modules include a physical interface 1308 with the process equipment. In aspects, the interface is fully integrated with a single-use system comprising single use pre-calibrated consumables in a closed, sterile system. Another module includes scalable in-line and on-line process measurement technologies 1314 which measure critical control points (CCPs) and CQAs for process control and release testing. Also included is a calibration and signal processing 1312 module. In aspects, the calibration and signal processing 1312 module is pre- or auto-calibrated. In aspects, the calibration and signal processing 1312 module includes straightforward calibration workflows not disruptive to the process and/or where limited recalibration is required.

In aspects, the PAT Box apparatus 900 may track in real-time the progress of a process and transmit data until a desired optimization is reached or the process terminates.

In aspects, the PAT Box apparatus 900 is configured to control upstream and downstream unit operations via included compatibility with industry standard systems including, for example, Delta V™, Ignition™, Unicorn™, Wonderware™, MFCS™, and OPC-UA™. In aspects, the PAT Box apparatus 900 controls upstream and downstream unit operations based on analytical results gathered by all process analytic instruments, e.g., in-line, at-line, on-line, and off-line.

FIG. 13B schematically illustrates another embodiment of a PAT Box apparatus 900 as described herein. The figure illustrates the data flow and data processing of the apparatus 900. Shown is the PAT instrument stack 908 and the PAT control cabinet 910 of the apparatus 900 which integrate with local and/or remote data storage 1342 for management and storage of data and a distributed control system (DCS)/process control system (PCS) 1340 for performing optimization algorithms, advanced control strategies, and device level controls.

In some embodiments, the PAT Box apparatus 900 may include a PAT management software (within the dashed lines of the PAT control cabinet 910) of the PAT management and operations logic. The PAT management software may be designed as a modular and scalable solution that integrates with an existing DCS/PCS 1340. The high-level components of the system include the SCADA/historian 1322, the PAT knowledge management software 1326 integrated with the multivariate data analysis tools 1324, and a local and/or remote data storage server 1342 executing locally on the APC and/or remotely on a server computer such as a cloud server.

The SCADA/historian 1322 software layer may issue commands to and collect data from the PAT instruments of the PAT instrument stack 908 such as the instruments listed in Table 1 or other instruments described herein. The SCADA/historian 1322 may use industry-standard protocols—Open Platform Communications Unified Architecture (OPC-UA)—to communicate with the PAT instruments and obtain data in real-time. The SCADA/historian 1322 may also communicate with a DCS or PCS to obtain process data (such as pH, temperature, pressure, and/or the like) and send commands to the PAT instruments.

The PAT knowledge management software 1326 integrated with the multivariate data analysis tools 1324 may include a model processing system to perform immediate analysis on raw data captured from PAT instruments using statistical and machine learning models to analyze the incoming data in real-time. The model processing system hosts and manages machine learning models that are developed to predict critical quality attributes of the process fluid of the process stream coupled with the PAT Box apparatus 900. The model processing system may also communicate the models' results back to SCADA/historian 1322 software layer for storage in the local and/or remote data storage server 1342 and for visualization via a local and/or remote HMI or display.

The local and/or remote data storage server 1342 may include a central sequel (SQL) database that hosts a central repository for raw and processed data. The SQL database records changes made by users in PAT management software and alarms for troubleshooting and enabling an audit trail. The SQL database may also enable users to extract historic data obtained and analyzed by PAT management software.

FIGS. 13C through 13N illustrate embodiments of one or more graphical user interfaces to provide visualizations of the product quality attributes such as CQAs captures from one or more PAT instruments for a process. Users can interact with PAT management software of the PAT management and operations logic using the user interface shown in FIG. 13C. The user interface main page 1350 consists of six sections, each highlighting one instrument. Users can click on each section to navigate to the orchestration page of each instrument. FIGS. 13D, 13E, and 13F highlight the page to orchestrate the Raman instrument 1352, the operation dashboard to visualize models' predictions, and the advanced dashboard to visualize more parameters for models. Other instruments (NIR 1357, MIR 1356, DLS 1354, MALS 1355, and UV-VIS 1353) have dedicated orchestration pages, operation, and advanced dashboards similar to the Raman instrument 1352.

Users can click on DLS 1354, MALS 1355, and UV-VIS 1353 sections to specify measurement acquisition settings, start and stop the measurements. Once measurements start, real-time CQAs will be visualized in the main page of a graphical user interface for the PAT management software. DLS 1354, MALS 1355, and UV-VIS 1353 measurements do not require modelling to measure CQAs as their native software converts the measurements into CQA readings and provides the results directly to PAT management software to store and visualize. However, advanced models can be incorporated into PAT software for these instruments to predict more CQAs.

FIG. 13D illustrates a user interface 1360 (orchestration page) to automate the MarqMetrix all-in-one Raman instrument. Two faceplates are provided at bottom right section for users to enter Raman acquisition settings, enter measurement names, and choose a model to predict corresponding CQAs.

FIG. 13E illustrates a user interface 1362 to visualize Raman models predictions as a function time and sample number.

FIG. 13F illustrates a user interface 1364 to visualize raw Raman spectra (top left), preprocessed Raman spectra (top right), models' Hotelling's T2 (bottom left), and distance to the model of X-space (DModX) (bottom right).

FIG. 13G illustrates a user interface 1366 showing a data analysis page of PAT management software where users can see past data collections and export data.

FIG. 13H illustrates a user interface 1368 showing a model registry page of PAT management software where users can see all models, add new models, upgrade current models, and archive current models.

FIG. 13I illustrates a user interface 1370 showing an Alarm Summary page of PAT management software where users can see all alarms raised by PAT management software. Alarms may be colored based on their status (active and cleared) and priority (low, medium, high, and critical).

FIG. 13J illustrates a user interface 1372 showing an Audit Trail page of PAT management software where users can see all actions and its details including actors, time, and areas impacted.

FIG. 13K illustrates a user interface 1374 to illustrate using PAT management software in mRNA manufacturing process. A user may access the user interface 1372 using PAT management software to automate Raman instrument on IVT for internal test run. By clicking on the Start button, users can enter run name, choose a model, and specify batch ID and unit operation.

FIG. 13L illustrates a user interface 1376 to illustrate using PAT management software in mRNA manufacturing process. A user may access the user interface 1376, which is a Raman orchestration page of PAT management software, where incoming raw Raman spectrum is plotted on the left side of the screen and model predictions for concentration of mRNA, adenosine triphosphate (ATP), cytidine triphosphate (CTP), guanosine triphosphate (GTP), and N1-methyl pseudouridine triphosphate (NMPUTP) are plotted on the right side of the screen. Raman measurement status is shown on the bottom left side of the screen.

FIG. 13M illustrates a user interface 1378 to illustrate using PAT management software in mRNA manufacturing process. A user may access the user interface 1378 showing an operation dashboard for the Raman model with model predictions for concentration of mRNA, ATP, CTP, GTP, and NMPUTP in wheel plot (left) and line plot (right).

FIG. 13N illustrates a user interface 1380 to illustrate using PAT management software in mRNA manufacturing process. A user may access the user interface 1380 showing an advanced dashboard for the Raman model with raw Raman spectrum (top left), preprocessed Raman spectrum (top right), Hotelling's T2 and critical Hotelling's T2 (bottom left), and DModX and critical DModX (bottom right).

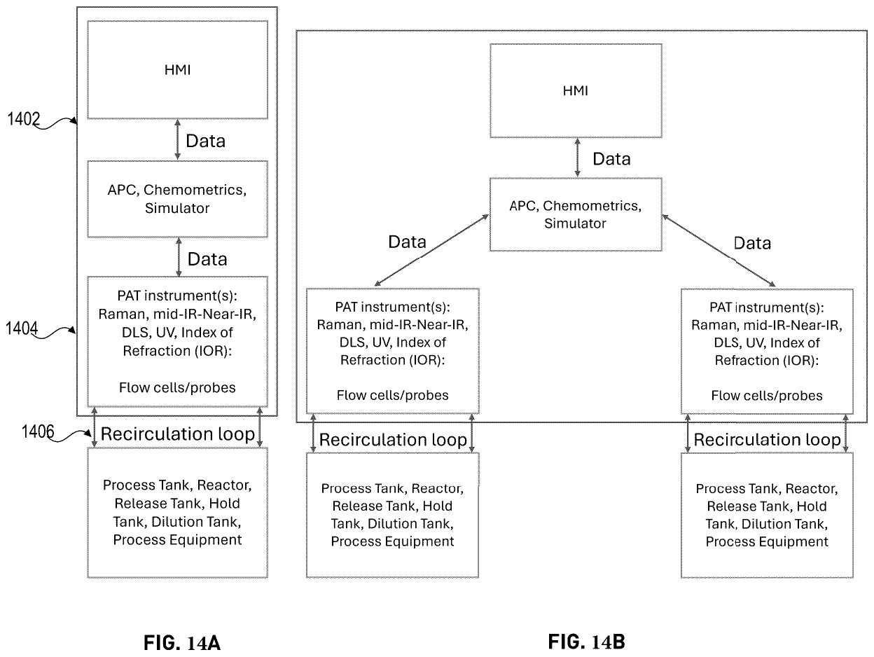

FIG. 14A schematically illustrates PAT control cabinet 1402 including a human machine interface (HMI), a controller, depicted as an advanced process controller (APC), and software layers of the PAT management and operations logic including a data acquisition layer that acquires and stores data from the in-line and at-line instruments, as well as any optional off-line instruments. In aspects, the data acquisition layer also functions to close a control loop by communicating with a distributed control system (DCS) or SCADA system. In aspects, the data acquisition layer may also report process data to historians and other databases. In aspects, the data acquisition layer may include additional software for performing process modeling such as chemometric modeling and/or other advanced process modeling, for example to process the raw data into product quality attribute information such as CQAs.

Also illustrated is a PAT instrument stack 1404 including one or more analytic instruments and associated flow cells and probes. Exemplary flow cells that may be included are a Raman flow cell, a UV/VIS flow cell, a mid-IR flow cell, a near-IR flow cell, a DLS flow cell, and an index of refraction (IoR) flow cell, as described in more detail infra.

As illustrated, the PAT Box apparatus is in fluid communication via a recirculation loop 1406 with, e.g., a unit operation of a pharmaceutical or biopharmaceutical manufacturing process, or an external vessel such as a process tank, a release tank, a hold tank, a mixing tank or a dilution tank, as described in more detail infra. The recirculation loop 1406 may be connected via one or more valves to one or more of a material recycle flow path, a waste flow path, and a forward processing flow path.

FIG. 14B schematically illustrates an embodiment where two PAT Box apparatuses are connected via an electronic feedback loop to a PAT control cabinet where the HMI is configured for two-way communication with the instruments of the PAT instrument stack. As depicted here, each set of analytic instruments is in fluid communication via a recirculation loop with a unit operation, which may be e.g., a bioreactor, a chromatography apparatus, a filtration apparatus, etc., or a process vessel, which may be e.g., a hold tank, a mixing tank, etc.

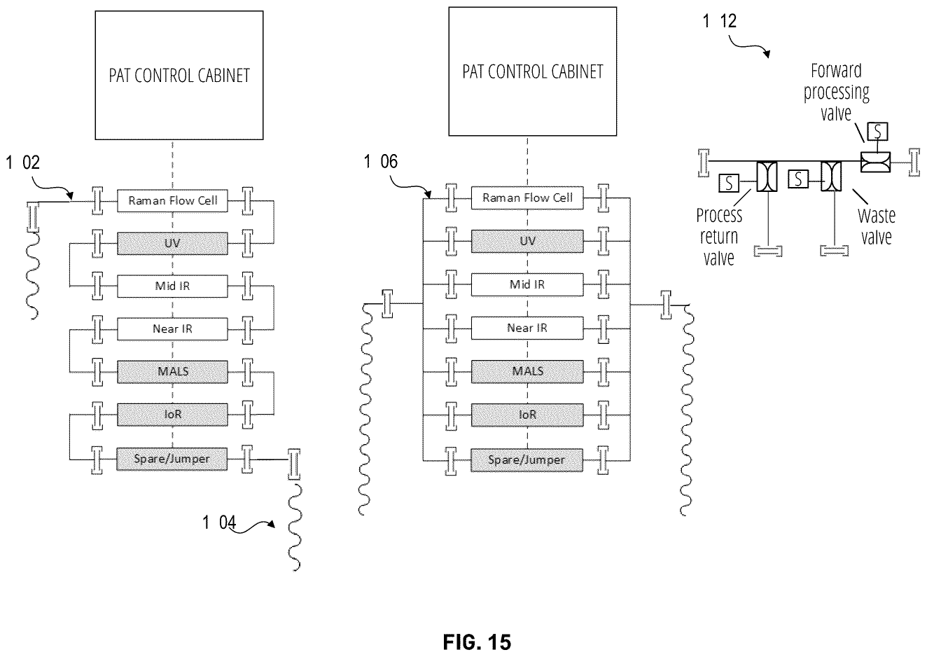

FIG. 15 is a schematic illustration of the flow cells of the PAT instrument stack. The flow cells may be arranged either in series (left) 1502 to 1504 or in parallel (right) 1506 in relation to the flow path, depending on the needs of the end-user. For example, flow cells connected in series allow for a “plug and play” configuration in which additional flow cells may be added end to end on the string of PAT flow cells, as needed. This configuration occupies a larger footprint compared to flow cells configured in parallel. Flow cells configured in parallel occupy a smaller footprint, but are somewhat less flexible than a series configuration because flow cell tubesets and/or piping need to be preconfigured.

The schematic illustrates exemplary flow cells that may be included in a flow kit. These include a Raman flow cell, a UV/VIS flow cell, a mid-IR flow cell, a near-IR flow cell, a multi-angle light scattering (MALS) instrument flow cell, and an index of refraction (IoR) flow cell. In an aspect, the UV/VIS flow cell is a variable pathlength flow cell such as a FlowVPX® flow cell available from Repligen Corp.

The provision of customized flow kits suitable for different production modalities highlights the versatility of the PAT Box apparatus. Different production modalities, such as RNA, DNA, monoclonal antibody, viral vector, etc., may require different technologies to measure relevant product criteria, including product quality attributes. When comparing testing methods between modalities, there are some technologies that measure product attributes for multiple modalities and some than can only measure product attributes for a single modality. For example, some forms of spectroscopy can measure both RNA concentration and protein concentration. However, a MALS device may be able to measure lipid nanoparticle size for an RNA production line, but it may not be able to measure any product attributes for a monoclonal antibody process.

This problem is addressed by the provision of a plurality of modular flow kits, each adapted to a production modality. The modular flow kits are adapted for ease of replacement such that one may be easily removed and replaced with another. This allows for a single PAT Box apparatus to be utilized for multiple different modalities of production. For example, where the modality is RNA production, the flow kit may include RNA specific flow cells such as Mid IR, Near IR, and MALS.

In another example, where the modality is antibody production, the flow kit may include protein specific flow cells such as IoR, DLS, FT-IR, and fluorescence. However, applications of a PAT Box skid are not intended to be limited to the RNA gene therapy bioprocess modality. The PAT Box skid can be applied to other modalities in the pharmaceutical manufacturing industry as well as other industries such as, but not limited to, food, purified water, and buffer solutions manufacturing. PAT Box skids may include one or more PAT Box apparatuses as well as additional hardware such as a vessel for capturing and measuring samples.

Accordingly, in aspects, a flow cell tubeset may be provided as a flow kit for installation in a PAT Box with in-line process analytical instruments in a series or parallel flow path configuration along with associated tubing, valves, and connectors. In one aspect is provided a single use flow kit where the flow cells are arranged either in series or in parallel. For example, in FIG. 15, the flow cells in white, Raman, MidIR, and NearIR, may be supplied as a single use flow kit including single-use tubing, connectors, and flow cell components. Not all components may be single use and may need to be removed from the flow kit after use for cleaning and/or sanitization.

In another aspect, provided is a single use flow kit with smart waste and release valves where the flow cells are arranged in either a series or parallel configuration and the kit includes associated tubing, valves, and connectors. In accordance with this aspect, provided are multiple outlets connecting to single use “smart” pinch valves for waste and forward processing. In an aspect, single use tubing is placed into permanent pinch valves for use during processing. Once the batch is complete, the flow kit is removed from the holders (not shown) and pinch valves are discarded. In an aspect, the pinch valves may be automated solenoid pinch valves.

In another aspect, provided is a single use flow kit with smart return, waste and release valves where the flow cells are arranged in either a series or parallel configuration and the kit includes associated tubing, valves, and connectors. In accordance with this aspect, provided are multiple outlets connecting to single use “smart” pinch valves for process return material, waste, and forward processing. The single use tubing is placed into permanent pinch valves for use during processing. Once the batch is complete, the flow kit is removed from the holders (not shown) and pinch valves and discarded.

Shown as an inset in FIG. 15 is an exemplary configuration of a smart valve set 1512 including a process return valve, a waste valve, and a forward processing valve. In aspects, these valves may be automated solenoid pinch valves.

The flow cells of the PAT instrument stack may be fluidly connected to one or more unit operations and/or vessels via suitable connectors 1506 and tubing 1504. In aspects, the tubing 1504 may be flexible tubing. The flow cells and flexible tubing can be connected to each other and unit operations via any suitable connector. Suitable connectors include, for example, sanitary tri-clamp connectors, hose barb connectors, tube compression connectors, quick connects, aseptic connectors, or other standard connectors used in the biopharmaceutical industry.

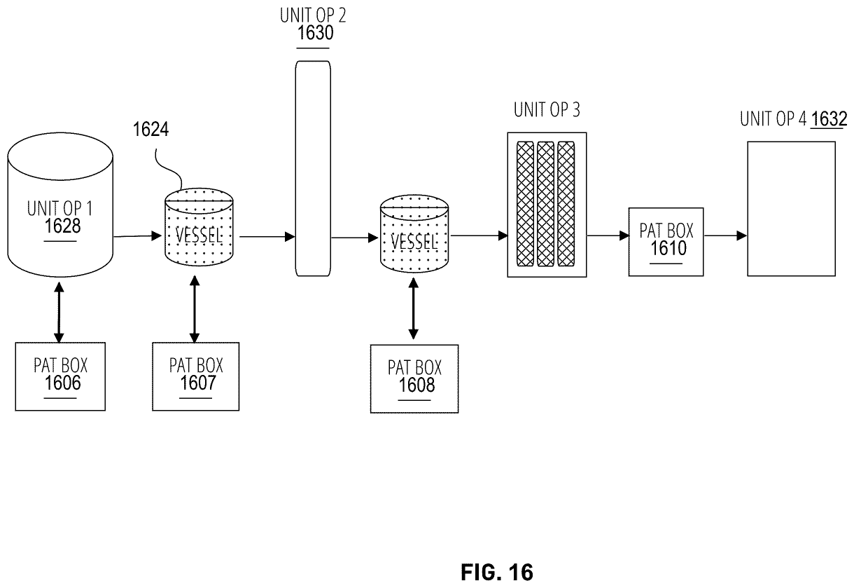

FIG. 16 is a schematic illustrating a configuration of a manufacturing process where a plurality of PAT Box apparatuses (PAT Boxes) are integrated in different ways. As depicted here, the manufacturing process may be made continuous or integrated with surge or hold vessels configured between the unit operations. PAT Boxes may be integrated and connected to these vessels to monitor and control the process. PAT Boxes may also be placed in-line between unit operations or integrated directly into a unit operation, for example to monitor an IVT reaction, a cell culture, or fermentation. With reference to FIG. 16, a first PAT Box 1606 is configured to recirculate process fluid from a first unit operation 1628 and return the process fluid to the same unit operation. The next two PAT Boxes 1607 and 1608 are configured to connect to an external vessel 1624 which is in-line between two unit operations in the process. The external vessel 1624 may comprise a body in the form of a flexible or a rigid container defining an interior space, inlet and outlet ports, an optional impeller for fluid recirculation, and an optional probe or sensor. The external vessel may be a hold vessel, a release tank, a dilution tank, or a stirred tank reactor and may include one or more of an IO port for data transfer and one or more analytical detectors, sensors and/or probes. A third PAT Box 1610 is situated in-line between the last two unit operations in the process.

It is understood that here also the flow path may be configured such that the process fluid from a given unit operation recirculates through the flow cells of the in-line PAT Box and returns to the same unit operation, and/or the flow path may contain one or more “smart” valves configured to control the flow of process fluid back to a unit operation for recycling, or to the waste container, or forward to the next unit operation in the manufacturing process, depending on whether or not predetermined criteria are satisfied, as discussed above.

While the invention herein disclosed has been described by means of specific embodiments and applications thereof, numerous modifications and variations could be made thereto by those skilled in the art without departing from the scope of the invention set forth in the claims.

It will be appreciated that the present invention is set forth in various levels of detail in this application. In certain instances, details that are not necessary for one of ordinary skill in the art to understand the invention, or that render other details difficult to perceive may have been omitted. The terminology used herein is for the purpose of describing particular embodiments only and is not intended to be limiting beyond the scope of the appended claims. Unless defined otherwise, technical terms used herein are to be understood as commonly understood by one of ordinary skill in the art to which the disclosure belongs.

Various features of a process system may be used independently of, or in combination, with each other. It will be appreciated that a system as disclosed herein may be embodied in different forms and should not be construed as limited to the illustrated embodiments of the figures.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with one or more other features to yield a still further embodiment. Thus, it is intended that the present subject matter covers such modifications and variations as come within the scope of the appended claims and their equivalents.

In view of the above, it should be understood that the various embodiments illustrated in the figures have several separate and independent features, which each, at least alone, has unique benefits which are desirable for, yet not critical to, the presently disclosed vessel, system, and associated method. Therefore, the various separate features described herein need not all be present in order to achieve at least some of the desired characteristics and/or benefits described herein.

The foregoing discussion has broad application and has been presented for purposes of illustration and description and is not intended to limit the disclosure to the form or forms disclosed herein. It will be understood that various additions, modifications, and substitutions may be made to embodiments disclosed herein without departing from the concept, spirit, and scope of the present disclosure. In particular, it will be clear to those skilled in the art that principles of the present disclosure may be embodied in other forms, structures, arrangements, proportions, and with other elements, materials, and components, without departing from the concept, spirit, or scope, or characteristics thereof. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. While the disclosure is presented in terms of embodiments, it should be appreciated that the various separate features of the present subject matter need not all be present in order to achieve at least some of the desired characteristics and/or benefits of the present subject matter or such individual features. One skilled in the art will appreciate that the disclosure may be used with many modifications or modifications of structure, arrangement, proportions, materials, components, and otherwise, used in the practice of the disclosure, which are particularly adapted to specific environments and operative requirements without departing from the principles or spirit or scope of the present disclosure. For example, elements shown as integrally formed may be constructed of multiple parts or elements shown as multiple parts may be integrally formed, the operation of elements may be reversed or otherwise varied, the size or dimensions of the elements may be varied. Similarly, while operations or actions or procedures are described in a particular order, this should not be understood as requiring such particular order, or that all operations or actions or procedures are to be performed, to achieve desirable results. Additionally, other implementations are within the scope of the following claims. In some cases, the actions recited in the claims can be performed in a different order and still achieve desirable results. The presently disclosed embodiments are therefore to be considered in all respects as illustrative and not restrictive, the scope of the claimed subject matter being indicated by the appended claims, and not limited to the foregoing description or particular embodiments or arrangements described or illustrated herein. In view of the foregoing, individual features of any embodiment may be used and can be claimed separately or in combination with features of that embodiment or any other embodiment, the scope of the subject matter being indicated by the appended claims, and not limited to the foregoing description.

In the foregoing description and the following claims, the following will be appreciated. The phrases “at least one”, “one or more”, and “and/or”, as used herein, are open-ended expressions that are both conjunctive and disjunctive in operation. The terms “a”, “an”, “the”, “first”, “second”, etc., do not preclude a plurality. For example, the term “a” or “an” entity, as used herein, refers to one or more of that entity. As such, the terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, counterclockwise, and/or the like) are only used for identification purposes to aid the reader's understanding of the present disclosure, and/or serve to distinguish regions of the associated elements from one another, and do not limit the associated element, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority but are used to distinguish one feature from another.

In the claims, the term “comprises/comprising” does not exclude the presence of other elements, components, features, regions, integers, steps, operations, etc. Additionally, although individual features may be included in different claims, these may possibly advantageously be combined, and the inclusion in different claims does not imply that a combination of features is not feasible and/or advantageous. In addition, singular references do not exclude a plurality. Reference signs in the claims are provided merely as a clarifying example and shall not be construed as limiting the scope of the claims in any way.

1.-24. (canceled)

25. An apparatus comprising:
a memory;
processing circuitry coupled with the memory to perform operations to establish monitoring for a Critical Quality Attribute (CQA) in real-time for an in-line instrument of a manufacturing process, the operations to:
establish one or more parameters for collecting measurement data from the in-line instrument, wherein the measurement data comprises an array of raw data per measurement;
select a machine learning model for the in-line instrument from a library of machine learning models, based on the manufacturing process and a stage of the manufacturing process associated with an interconnection of the in-line instrument with the manufacturing process, to generate a prediction for the CQA based on data collected from the in-line instrument;
collect, based on the one or more parameters, the measurement data in real-time from the in-line instrument;
process the measurement data from the in-line instrument to generate real-time transformed data for the CQA and to predict a model output, the model output comprising trending data for the CQA; and
store the trending data in a data storage device.

26. The apparatus of claim 25, further comprising a base and an in-line flow cell head coupled with the base via an arm, wherein a controller comprises the memory and the processing circuitry, wherein the base comprises a control cabinet housing the controller and the base comprises an instrument stack including the in-line instrument.

27. The apparatus of claim 25, wherein the apparatus is part of a server computer connected with a process analytic technology (PAT) box apparatus via a network connection.

28. The apparatus of claim 25, wherein the operations to establish one or more parameters for collecting measurement data from the in-line instrument comprises operations to establish the one or more parameters specific to the manufacturing process and specific to each unit operation coupled with the in-line instrument in that manufacturing process, wherein the CQA comprises a volume, a concentration, or a mass.

29. The apparatus of claim 25, wherein the operations further comprise operations to pass the trending data to a management and orchestration system and display the real-time transformed data and trending data on a display.

30. The apparatus of claim 25, wherein the in-line instrument comprises a Raman analyzer and a specific unit operation for the Raman analyzer comprises in vitro transcription (IVT) reaction.

31. The apparatus of claim 25, wherein operations to store the trending data in a data storage device comprise operations for measurement sequencing, including operations to store the raw data, the real-time transformed data, and the trending data in a centralized database of PAT measurements and machine learning model outputs.

32. A non-transitory computer readable medium comprising instructions, which, when executed by any one or more processors in one or more computers, cause the one or more processors in the one or more computers to perform operations to establish monitoring for a Critical Quality Attribute (CQA) in real-time for an in-line instrument of a manufacturing process, the operations to:
establish one or more parameters for collecting measurement data from the in-line instrument, wherein the measurement data comprises an array of raw data per measurement;
select a machine learning model for the in-line instrument from a library of machine learning models, based on the manufacturing process and a stage of the manufacturing process associated with an interconnection of the in-line instrument with the manufacturing process, to generate a prediction for the CQA based on data collected from the in-line instrument;
collect, based on the one or more parameters, the measurement data in real-time from the in-line instrument;
process the measurement data from the in-line instrument to generate real-time transformed data for the CQA and to predict a model output, the model output comprising trending data for the CQA; and
store the trending data in a data storage device.

33. The computer readable medium of claim 32, wherein establishing one or more parameters for collecting measurement data from the in-line instrument comprises establishing the one or more parameters specific to the manufacturing process and specific to each unit operation coupled with the in-line instrument in that manufacturing process.

34. The computer readable medium of claim 32, wherein the operations further comprise operations to pass the trending data to a management and orchestration system and display the real-time transformed data and trending data on a display.

35. The computer readable medium of claim 32, the library of machine learning models comprises a set of specific unit operations for a process for manufacturing a pharmaceutical or biopharmaceutical product.

36. The computer readable medium of claim 35, wherein the set of specific unit operations comprise one of a IVT reaction, IVT pool, IVT pool dilution, tangential flow filtration 1 (TFF1) pool, TFF1 dilution, Oligo dT pool, tangential flow filtration 2 (TFF2) pool/release DS, lipid solution, DS dilution, LNP pool, tangential flow filtration 3 (TFF3) pool, post-sucrose, bulk DP, and release DP.

37. The computer readable medium of claim 36, wherein the in-line instrument includes one of a mRNA concentration—A260 (nanodrop), a mRNA concentration—Florescence (RiboGreen), an encapsulation—Florescence (RiboGreen), a mRNA purity—CE (Frag A), a mRNA integrity—CE (Frag A), a mRNA intactness, a percentage of fragmentation mRNA, an aggregate quantitation, a dsRNA content—Dot blot, a LNP size, polydispersity—DLS, a LNP surface charge morphology ζ-potential, a residual total protein—florescence (NanoOrange), a residual plasmid DNA—qPCR, a visual appearance—USP<790>, a subvisible particles, a particulate matter, a sucrose concentration—LC/CAD, a total lipid (ionizable, PEG, DSPC, cholesterol), an osmolality—mOsm/kg H₂O, a viscosity—USP<911>, a residual solvents, a residual E. coli HCP—ELISA, a residual nucleotides NTP—LC/MS, a pH, a bioburden Sterility—USP<1><61><71>, an endotoxin-USP<85>, a 5′ Capping efficiency—LC/MS, a 3′ poly(A) tail length variant distribution LC/MS, a sequence identification—illumina Sanger, a IVT potency—cell-based assay, a mRNA purity—LC CE Bioanalyzer, a mRNA content—UPLC and Rib green, a mRNA/Lipid mass (N:P ratio), an extractable volume, a container closure integrity (CCIT), and an immunogenicity.

38. A method to establish monitoring for a Critical Quality Attribute (CQA) in real-time for an in-line instrument of a manufacturing process comprising:
establishing one or more parameters for collecting measurement data from the in-line instrument, wherein the measurement data comprises an array of raw data per measurement;
selecting a machine learning model for the in-line instrument from a library of machine learning models, based on the manufacturing process and a stage of the manufacturing process associated with an interconnection of the in-line instrument with the manufacturing process, to generate a prediction for the CQA based on data collected from the in-line instrument;
collecting, based on the one or more parameters, the measurement data in real-time from the in-line instrument;
processing the measurement data from the in-line instrument to generate real-time transformed data for the CQA and to predict a model output, the model output comprising trending data for the CQA; and
storing the trending data in a data storage device.

39. The method of claim 38, wherein storing the trending data in a data storage device comprises measurement sequencing, including storing the raw data, the real-time transformed data, and the trending data in a centralized database of PAT measurements and machine learning model outputs, wherein the centralized database is accessible via a structured query language (SQL), wherein the raw data, the real-time transformed data, the trending data, and the machine learning models are auditable.

40. The method of claim 38, further comprising enabling two-way communication between any PAT that is capable of transferring data using Open Platform Communications Unified Architecture (OPC-UA) and Representational State Transfer Application Programming Interface (RestAPI).

41. The method of claim 38, wherein establishing one or more parameters comprises commanding acquisition parameters or measurement configurations for the in-line instrument and further comprising performing measurement sequencing, the measurement sequencing including acquiring measurement data, monitoring measurements status, raising errors if measurements fail, storing raw measurement data, transferring raw measurement data to a model execution web app, receiving transformed data and model outputs from the model execution web app, and storing transformed data and model outputs.

42. The method of claim 38, wherein processing the measurement data comprises enabling execution of Python models in a model execution web app, wherein the model execution web app receives the data from the measurement sequencing box and runs Python codes to process raw measurement data, wherein the model execution web app executes any Python models that can handle real-time data.

43. The method of claim 42, wherein any Python models comprises pre-treatment methods including interpolating functions, derivation, and normalization; multivariate models including principal component analysis (PCA) and partial least square (PLS) regression; and hybrid models by combining mechanistic equations and multivariate models.

44. The method of claim 38, further comprising enabling concurrent operation of multiple instruments and models.
